(19) United States
(12) Patent Application Publication
(10) Pub. No.: US 2020/0049366 A1
(43) Pub. Date: Feb. 13, 2020

(54) Duct Board System and Method

(71) Applicants: Bobby Dewayne Harris, Justin, TX (US); Edward Ray Lutts, Justin, TX (US)

(72) Inventors: Bobby Dewayne Harris, Justin, TX (US); Edward Ray Lutts, Justin, TX (US)

(21) Appl. No.: 16/101,249

(22) Filed: Aug. 10, 2018

(51) Int. Cl. F24F 13/02; F16L 25/00; F16L 9/00

(52) U.S. Cl. CPC F24F 13/0209; F24F 13/0245; F24F 13/0227; F16L 9/003; F16L 25/0009

(57) ABSTRACT

A duct board system/method utilizing extruded edge interconnection strips (EIS) is disclosed. The EIS are formed to allow linkage of planar duct board sheets (DBS) in a variety of connection methodologies including right angle corner connections (RAC), planar sheet connections (PSC), planar interface connections (PIC), and surface interface connections (SIC), without the need for specialized DBS cutting tools or fabrication dies. The EIS may incorporate provisions for spaced and/or on-demand fastener connection of DBS to the EIS, provisions for ridged/lobed/edged linkage of the DBS to the EIS, as well as provisions for edge sealed linkage of the DBS to the EIS.

### CROSS REFERENCE TO RELATED APPLICATIONS

Not Applicable

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to the use of duct board in the creation of heating ventilation and air conditioning (HVAC) plenum and air handling structures.

### BACKGROUND AND PRIOR ART (0100)-(0800)

Air handling structures used in HVAC systems may be constructed using a variety of materials. One common construction technique (as generally depicted in FIG. 1 (0100) and FIG. 2 (0200)) utilizes pre-insulated non-metallic ductwork (“duct board”) that comprises an insulating material (0111, 0211) (typically fiberglass) sandwiched between metalized sheets (0112, 0212, 0213) to form an insulated vapor barrier.

Fiberglass duct board panels (as generally depicted in FIG. 1 (0100) and FIG. 2 (0200)) provide built-in thermal insulation and the interior surface absorbs sound, helping to provide quiet operation of the HVAC system. As generally depicted in FIG. 3 (0300), the duct board is formed by sliding a specially-designed knife along the board using a straightedge as a guide. The knife automatically trims out a groove with 45° sides which does not quite penetrate the entire depth of the duct board, thus providing a thin section acting as a hinge. As generally depicted in FIG. 4 (0400)-FIG. 6 (0600), the duct board can then be folded along the groove to produce 90° folds, making the rectangular duct shape in the fabricator's desired size. The duct is then closed with outward-clinching staples and special aluminum or similar metal-backed tape.

### BRIEF SUMMARY OF THE INVENTION

The present invention pertains to a system and method that allows duct board sheets (DBS) to be assembled into HVAC ducts and other air containment structures without the need for special fabrication tooling and assembly methodologies. The present invention makes use of extruded edge interconnection strips (EIS) to interconnect the DBS into the desired HVAC air containment structures.

The EIS are formed to allow linkage of planar duct board sheets (DBS) in a variety of connection methodologies including right angle corner connections (RAC), planar sheet connections (PSC), planar interface connections (PIC), and surface interface connections (SIC), without the need for specialized DBS cutting tools or fabrication dies. These EIS structures may be formed in standardized lengths and trimmed as needed in the field to fit the exact dimensions of the desired HVAC duct. This procedure may be easily performed within air plenums and other confined spaces where the use of conventional duct board tooling is impractical or difficult. The various EIS structures may also incorporate extrusion tabs to provide vertical hanging support for the completed HVAC duct.

The EIS may incorporate provisions for spaced and/or on-demand fastener connection of DBS to the EIS, provisions for pinned/lobed/edged linkage of the DBS to the EIS, as well as provisions for edge sealed linkage of the DBS to the EIS. These features permit the DBS to be securely fastened to the EIS and provide for an enhanced vapor barrier within the completed HVAC duct.

### BRIEF DESCRIPTION OF THE DRAWINGS

For a fuller understanding of the advantages provided by the invention, reference should be made to the following detailed description together with the accompanying drawings wherein:

FIG. 1 illustrates perspective views of prior art duct board construction detail;

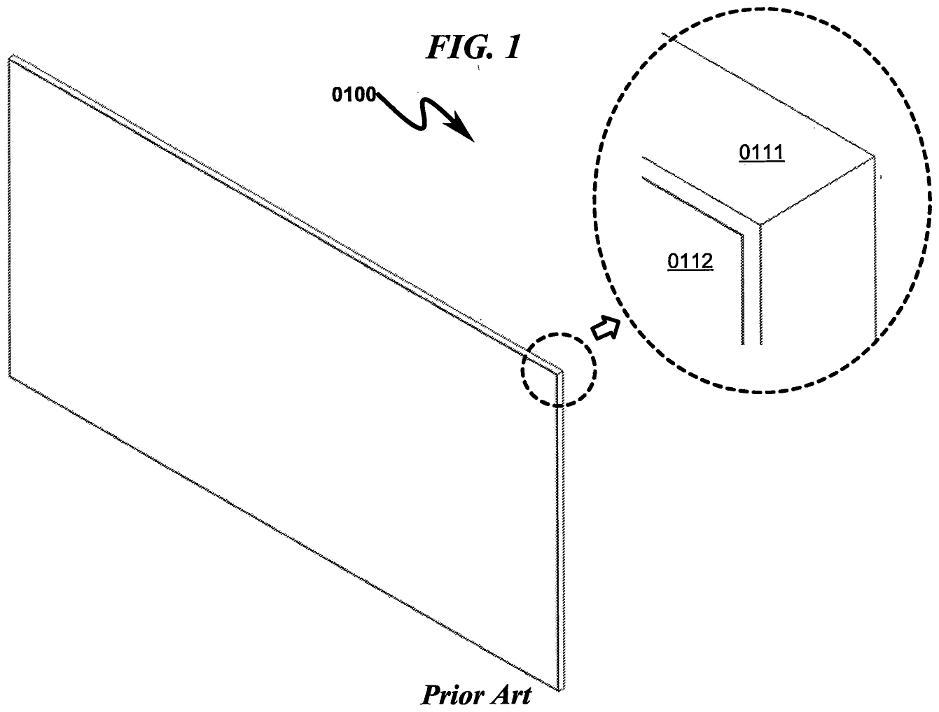

FIG. 2 illustrates side views of prior art duct board construction detail;

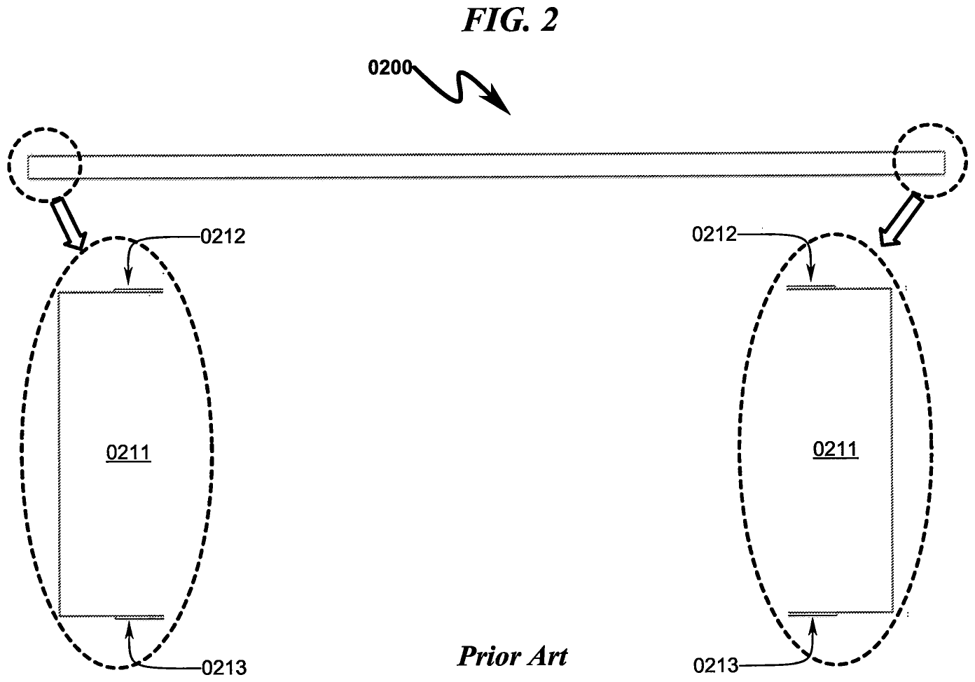

FIG. 3 illustrates perspective and side views of a prior art duct board scored for assembly into a HVAC duct;

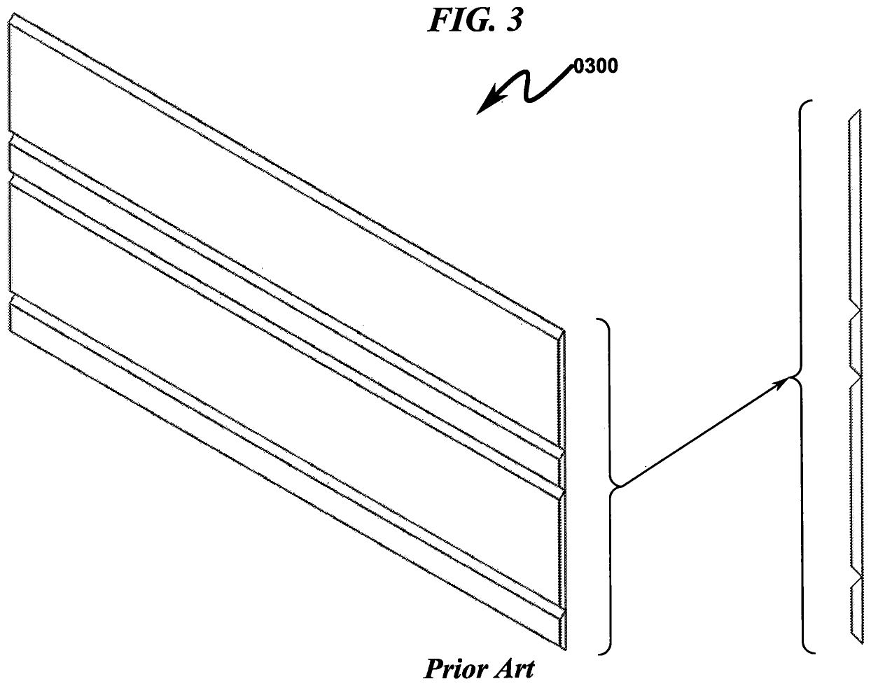

FIG. 4 illustrates a perspective view of a prior art duct board scored and folded into a HVAC duct;

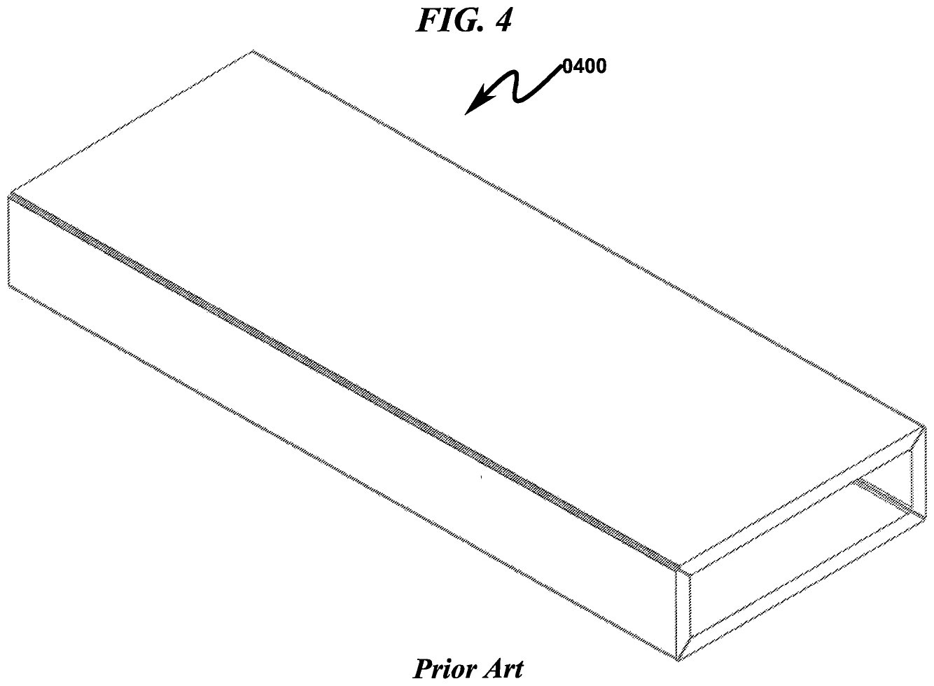

FIG. 5 illustrates a perspective end view detail of a prior art duct board scored and folded into a HVAC duct;

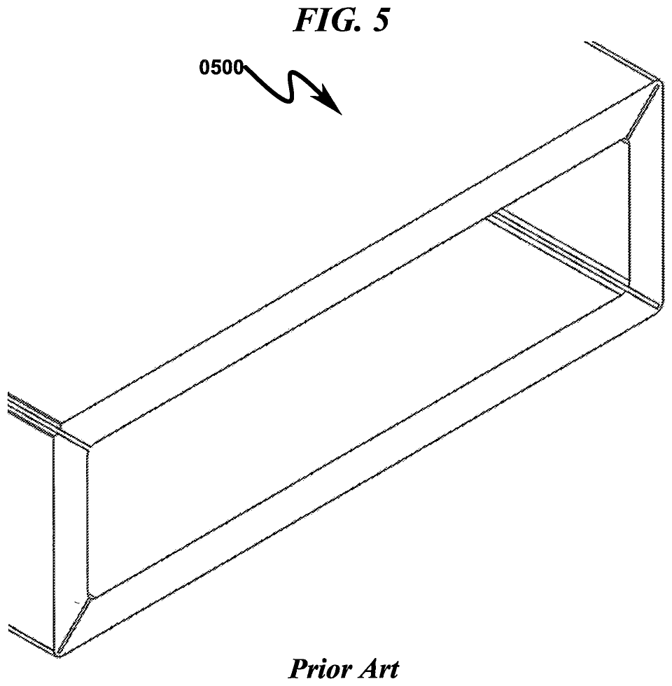

FIG. 6 illustrates an end view of a prior art duct board scored and folded into a HVAC duct;

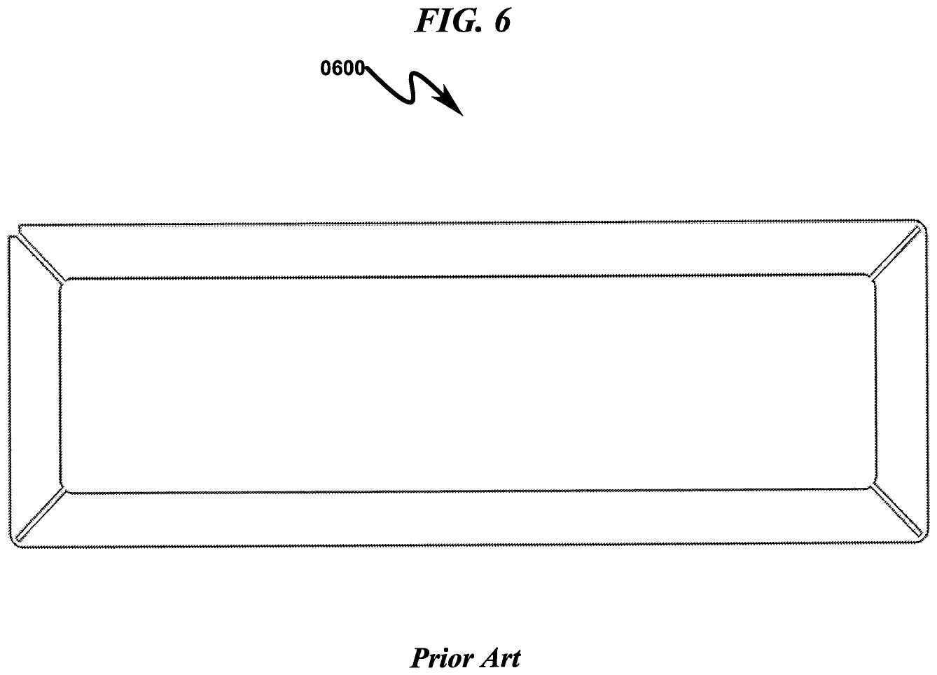

FIG. 7 illustrates a preferred exemplary invention embodiment EIS structure as applied to construction of a HVAC duct using right angle corner (RAC) EIS treatments;

FIG. 8 illustrates a preferred exemplary invention embodiment EIS structure as applied to construction of a HVAC duct using right angle corner (RAC) EIS treatments with planar interface connections (PIC);

FIG. 9 illustrates normalized extrusion profiles (NEP) depicting a number of right angle corner (RAC) extruded edge interconnection strip (EIS) variations;

FIG. 10 illustrates a preferred exemplary embodiment of an extrusion depicting a right angle corner (RAC) extruded edge interconnection strip (EIS);

FIG. 11 illustrates a preferred exemplary embodiment of formed sheet metal depicting a right angle corner (RAC) extruded edge interconnection strip (EIS);

FIG. 12 illustrates a top right front perspective view of a preferred exemplary RAC EIS extrusion embodiment;

FIG. 13 illustrates a top right rear perspective view of a preferred exemplary RAC EIS extrusion embodiment;

FIG. 14 illustrates a top right front perspective view of a preferred exemplary RAC EIS embodiment depicted as assembled with duct board;

FIG. 15 illustrates a bottom right front perspective view of a preferred exemplary RAC EIS embodiment depicted as assembled with duct board;

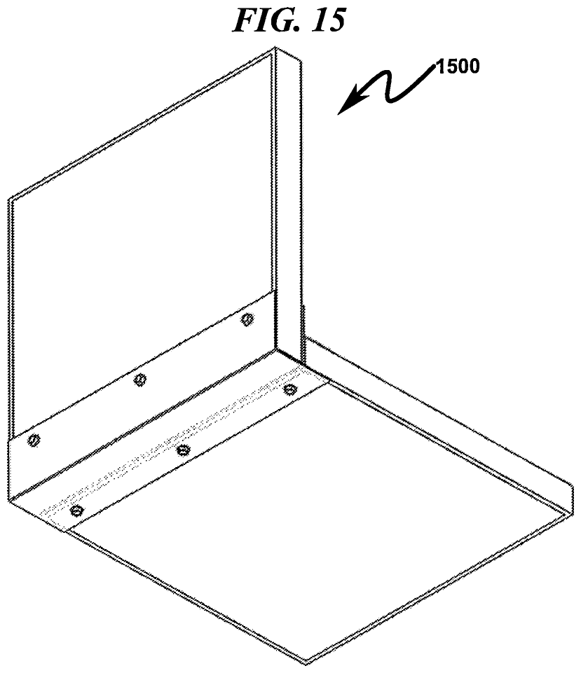

FIG. 16 illustrates a top right rear perspective view of a preferred exemplary RAC EIS embodiment depicted as assembled with duct board;

FIG. 17 illustrates a normalized extrusion profile (NEP) depicting a planar sheet connection (PSC) extruded edge interconnection strip (EIS);

FIG. 18 illustrates a preferred exemplary embodiment of an extrusion depicting a planar sheet connection (PSC) extruded edge interconnection strip (EIS);

FIG. 19 illustrates a preferred exemplary embodiment of formed sheet metal depicting a planar sheet connection (PSC) extruded edge interconnection strip (EIS);

FIG. 20 illustrates a top right front perspective view of a preferred exemplary PSC EIS extrusion embodiment;

FIG. 21 illustrates a top right rear perspective view of a preferred exemplary PSC EIS extrusion embodiment;

FIG. 22 illustrates a top right front perspective view of a preferred exemplary PSC EIS embodiment depicted as assembled with duct board;

FIG. 23 illustrates a bottom right front perspective view of a preferred exemplary PSC EIS embodiment depicted as assembled with duct board;

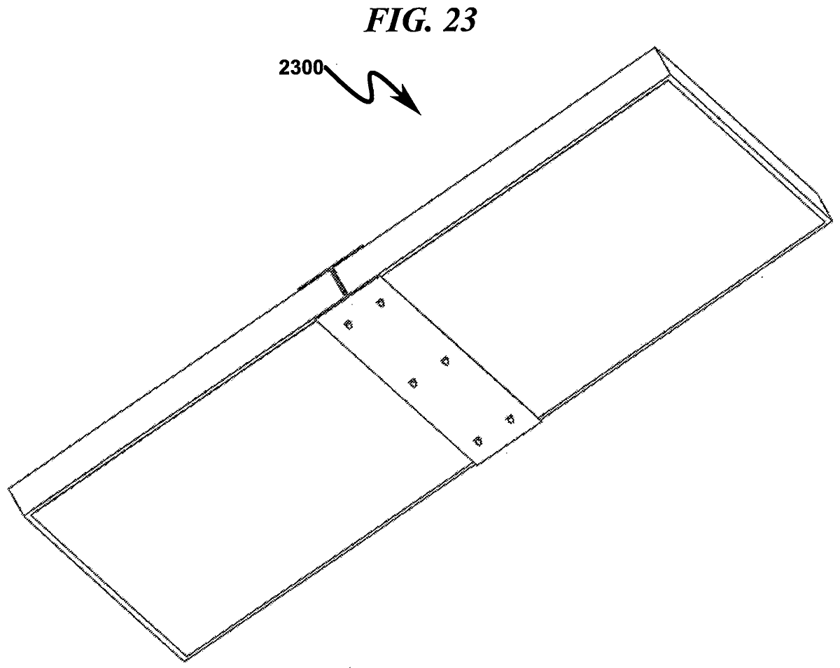

FIG. 24 illustrates a top right rear perspective view of a preferred exemplary PSC EIS embodiment depicted as assembled with duct board;

FIG. 25 illustrates a normalized extrusion profile (NEP) depicting a planar interface connection (PIC) extruded edge interconnection strip (EIS);

FIG. 26 illustrates a preferred exemplary embodiment of an extrusion depicting a planar interface connection (PIC) extruded edge interconnection strip (EIS);

FIG. 27 illustrates a preferred exemplary embodiment of formed sheet metal depicting a planar interface connection (PIC) extruded edge interconnection strip (EIS);

FIG. 28 illustrates a top right front perspective view of a preferred exemplary PIC EIS extrusion embodiment;

FIG. 29 illustrates a top right rear perspective view of a preferred exemplary PIC EIS extrusion embodiment;

FIG. 30 illustrates a top right front perspective view of a preferred exemplary PIC EIS embodiment depicted as assembled with duct board;

FIG. 31 illustrates a bottom right front perspective view of a preferred exemplary PIC EIS embodiment depicted as assembled with duct board;

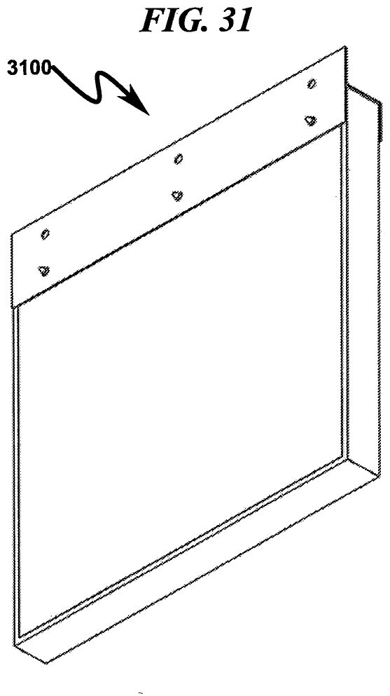

FIG. 32 illustrates a top right rear perspective view of a preferred exemplary PIC EIS embodiment depicted as assembled with duct board;

FIG. 33 illustrates a normalized extrusion profile (NEP) depicting a surface interface connection (SIC) extruded edge interconnection strip (EIS);

FIG. 34 illustrates a preferred exemplary embodiment of an extrusion depicting a surface interface connection (SIC) extruded edge interconnection strip (EIS);

FIG. 35 illustrates a preferred exemplary embodiment of formed sheet metal depicting a surface interface connection (SIC) extruded edge interconnection strip (EIS);

FIG. 36 illustrates a top right front perspective view of a preferred exemplary SIC EIS extrusion embodiment;

FIG. 37 illustrates a top right rear perspective view of a preferred exemplary SIC EIS extrusion embodiment;

FIG. 38 illustrates a top right front perspective view of a preferred exemplary SIC EIS embodiment depicted as assembled with duct board;

FIG. 39 illustrates a bottom right front perspective view of a preferred exemplary SIC EIS embodiment depicted as assembled with duct board;

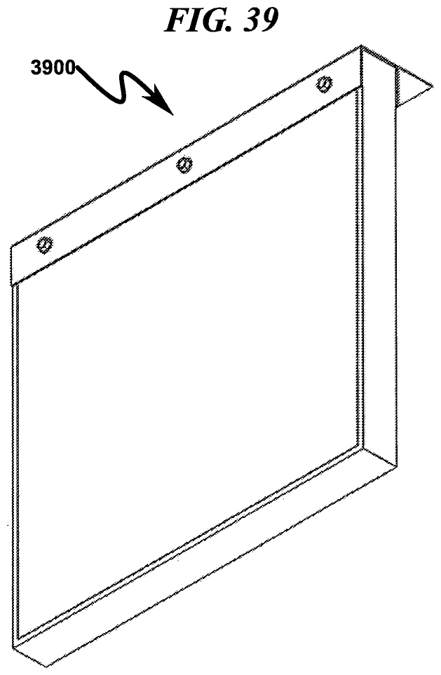

FIG. 40 illustrates a top right rear perspective view of a preferred exemplary SIC EIS embodiment depicted as assembled with duct board;

FIG. 41 illustrates a perspective view depicting a preferred exemplary RAC EIS incorporating EIS fastener connection mounting holes;

FIG. 42 illustrates a perspective view depicting a preferred exemplary PSC EIS incorporating EIS fastener connection mounting holes;

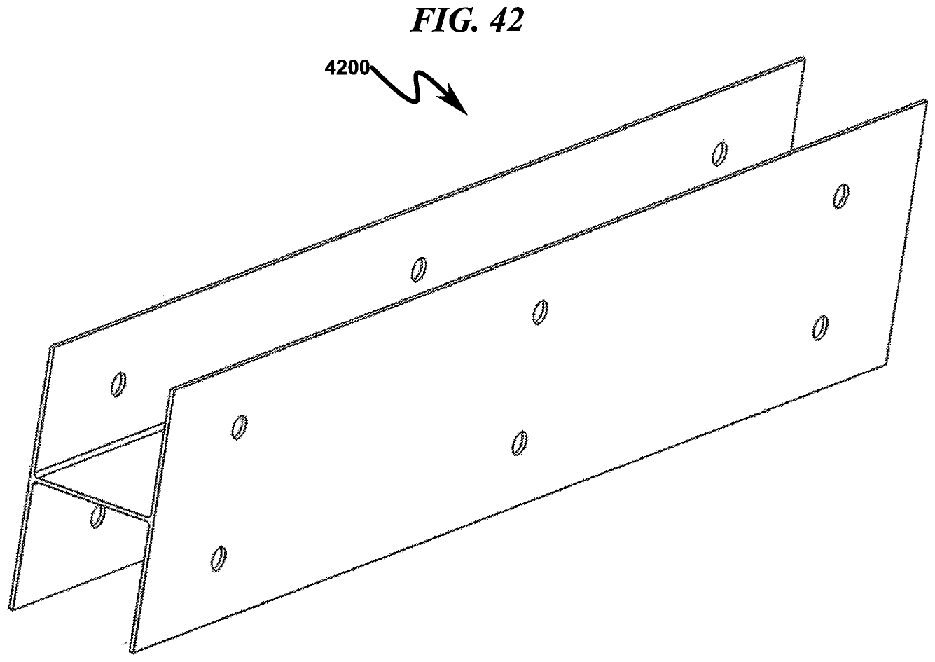

FIG. 43 illustrates a perspective view depicting a preferred exemplary PIC EIS incorporating EIS fastener connection mounting holes;

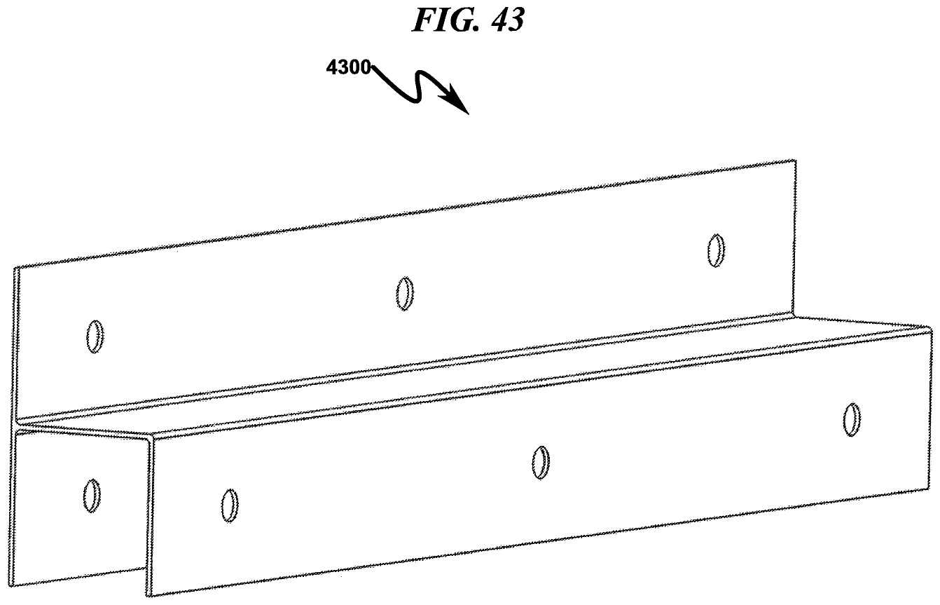

FIG. 44 illustrates a perspective view depicting a preferred exemplary SIC EIS incorporating EIS fastener connection mounting holes;

FIG. 45 illustrates an extrusion profile depicting a preferred exemplary invention embodiment employing an edge sealed DBS linkage implemented on a PCS EIS structure;

FIG. 46 illustrates an extrusion profile depicting a preferred exemplary invention embodiment employing a pin sealed DBS linkage implemented on a PCS EIS structure;

FIG. 47 illustrates an extrusion profile depicting a preferred exemplary invention embodiment employing a ridged DBS linkage implemented on a PCS EIS structure;

FIG. 48 illustrates an extrusion profile depicting a preferred exemplary invention embodiment employing a lobed DBS linkage implemented on a PCS EIS structure;

FIG. 49 illustrates perspective and profile views of a preferred exemplary EIS wire/strap support hangar clip;

FIG. 50 illustrates a top right front perspective view of a preferred exemplary EIS wire/strap support hangar clip supporting a typical EIS structure;

FIG. 51 illustrates a bottom right front perspective view of a preferred exemplary EIS wire/strap support hangar clip supporting a typical EIS structure;

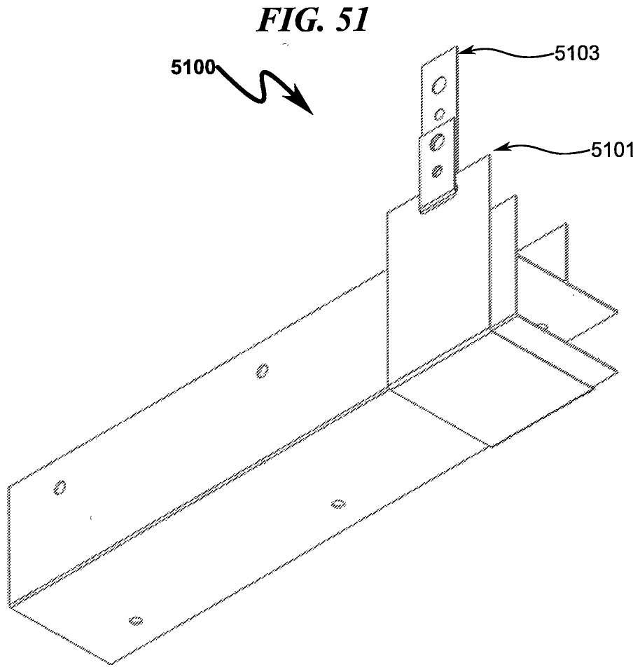

FIG. 52 illustrates a top right rear perspective view of a preferred exemplary EIS wire/strap support hangar clip supporting a typical EIS structure;

FIG. 53 illustrates perspective and profile views of a preferred exemplary EIS rod support hangar clip;

FIG. 54 illustrates a top right front perspective view of a preferred exemplary EIS rod support hangar clip supporting a typical EIS structure;

FIG. 55 illustrates a bottom right front perspective view of a preferred exemplary EIS rod support hangar clip supporting a typical EIS structure;

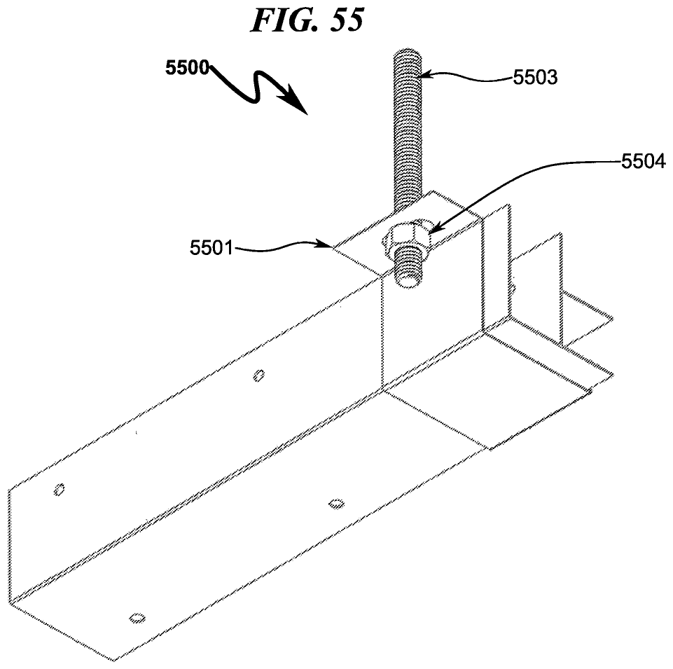

FIG. 56 illustrates a top right rear perspective view of a preferred exemplary EIS rod support hangar clip supporting a typical EIS structure;

FIG. 57 illustrates side profile views comparing a preferred exemplary right angle corner (RAC) EIS embodiment and a preferred exemplary RAC EIS embodiment incorporating a horizontal support tab;

FIG. 58 illustrates perspective views of a preferred exemplary RAC EIS embodiment incorporating a horizontal support tab including support fastening hole;

FIG. 59 illustrates side profile views comparing a preferred exemplary right angle corner (RAC) EIS embodiment and a preferred exemplary RAC EIS embodiment incorporating a vertical support tab;

FIG. 60 illustrates perspective views of a preferred exemplary RAC EIS embodiment incorporating a vertical support tab including support fastening hole;

FIG. 61 illustrates side profile views comparing a preferred exemplary compact right angle corner (RAC) EIS embodiment and a preferred exemplary RAC EIS embodiment incorporating a horizontal support tab;

FIG. 62 illustrates perspective views of a preferred exemplary compact RAC EIS embodiment incorporating a horizontal support tab including support fastening hole;

FIG. 63 illustrates side profile views comparing a preferred exemplary compact right angle corner (RAC) EIS embodiment and a preferred exemplary RAC EIS embodiment incorporating a vertical support tab;

FIG. 64 illustrates perspective views of a preferred exemplary compact RAC EIS embodiment incorporating a vertical support tab including support fastening hole;

FIG. 65 illustrates a top right front perspective view of an exemplary HVAC duct structure constructed using the present invention EIS RAC and PSC components;

FIG. 66 illustrates a bottom right front perspective view of an exemplary HVAC duct structure constructed using the present invention EIS RAC and PSC components;

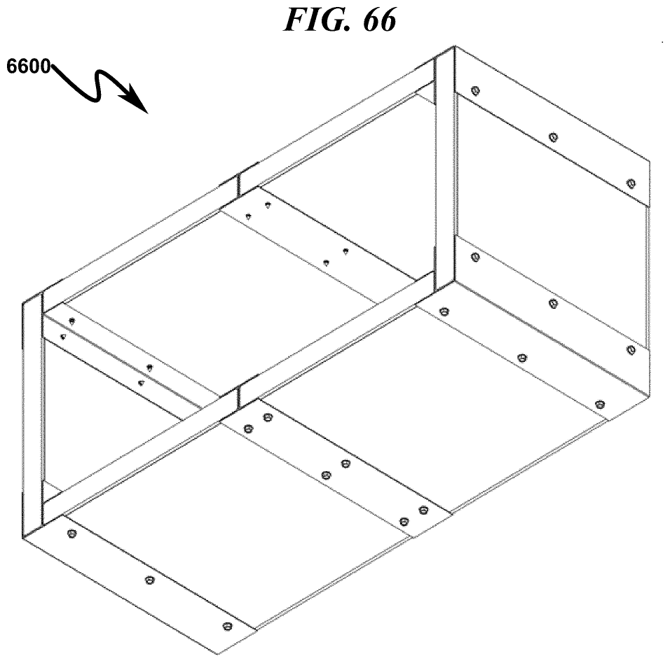

FIG. 67 illustrates a front view of an exemplary HVAC duct structure constructed using the present invention EIS RAC and PSC components;

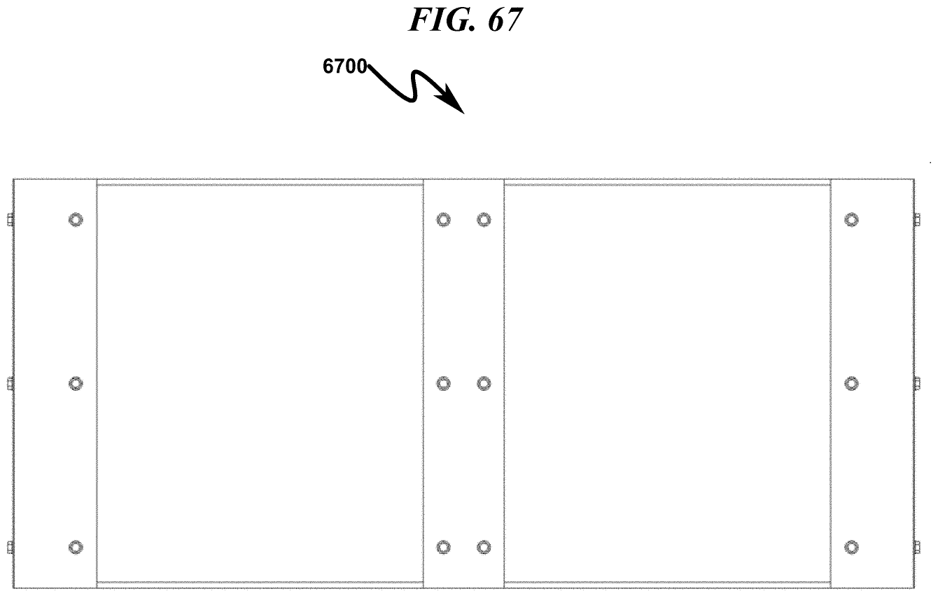

FIG. 68 illustrates a rear view of an exemplary HVAC duct structure constructed using the present invention EIS RAC and PSC components;

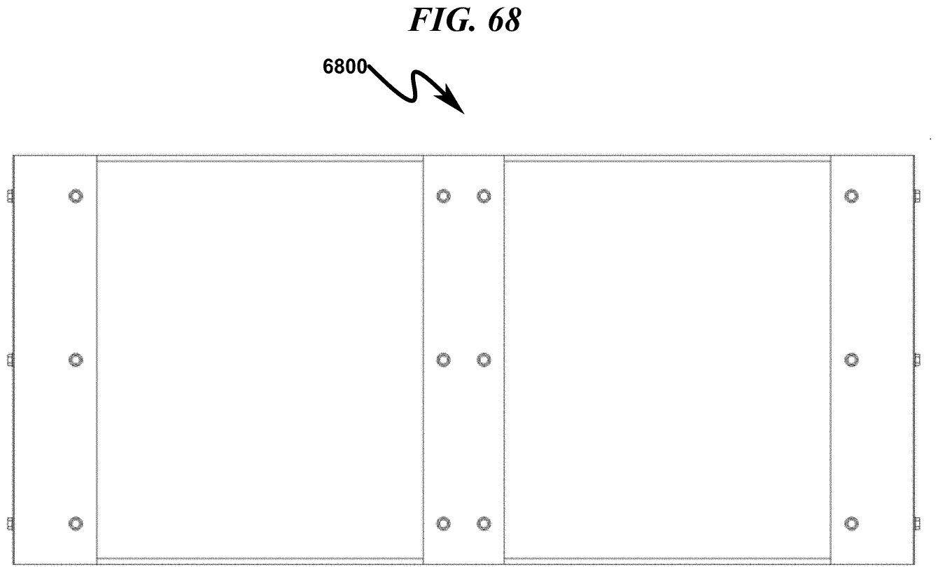

FIG. 69 illustrates a top view of an exemplary HVAC duct structure constructed using the present invention EIS RAC and PSC components;

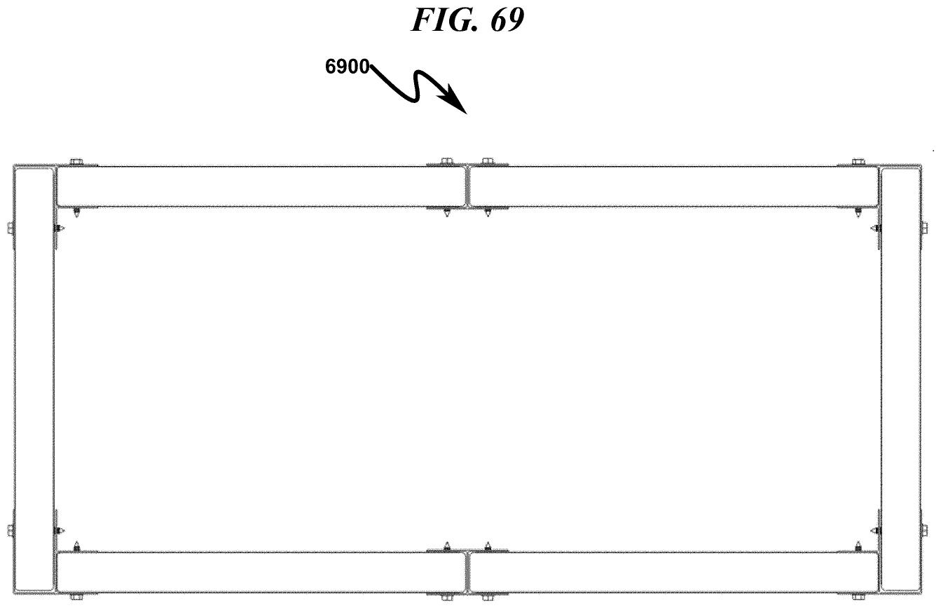

FIG. 70 illustrates a bottom view of an exemplary HVAC duct structure constructed using the present invention EIS RAC and PSC components;

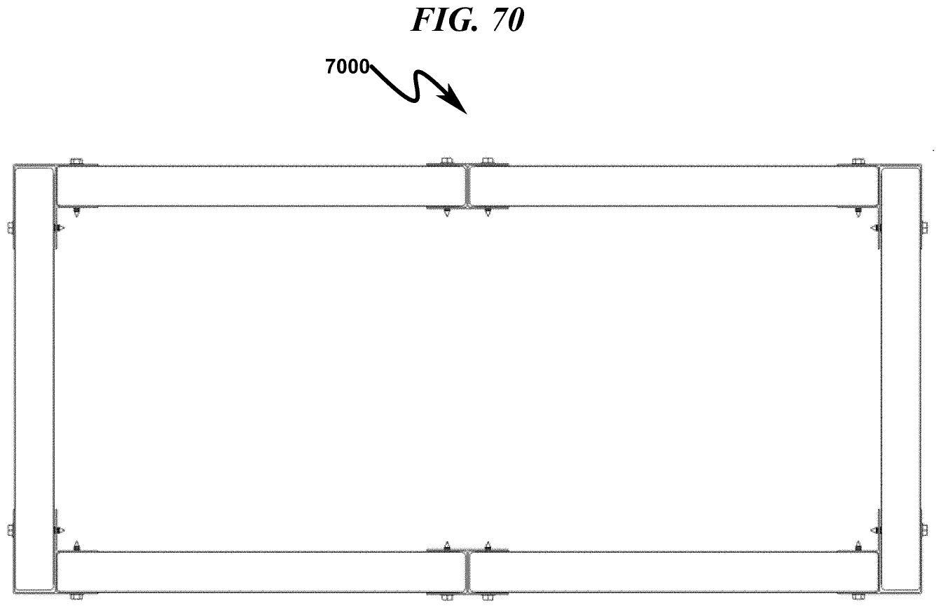

FIG. 71 illustrates a left side view of an exemplary HVAC duct structure constructed using the present invention EIS RAC and PSC components;

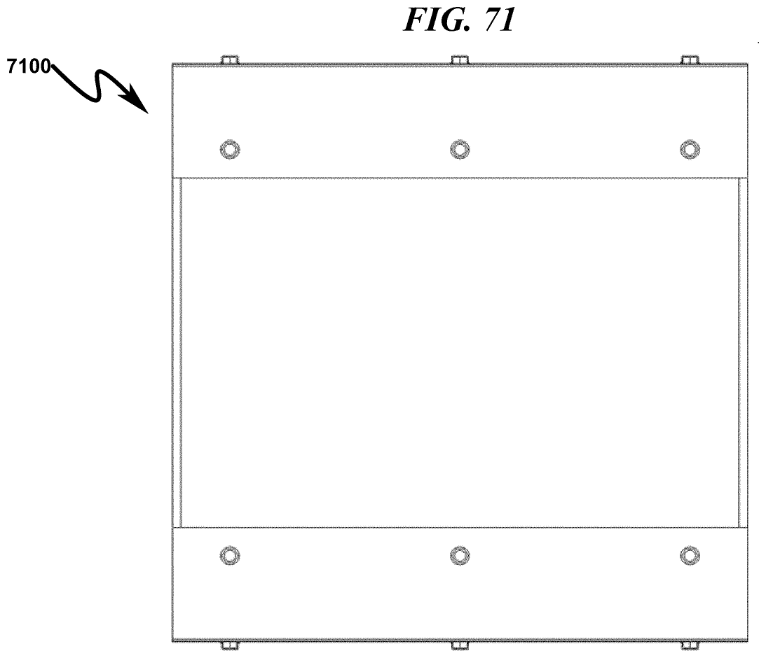

FIG. 72 illustrates a right side view of an exemplary HVAC duct structure constructed using the present invention EIS RAC and PSC components;

FIG. 73 illustrates a top right front perspective view of an exemplary HVAC duct structure constructed using the present invention EIS RCC and RAC vertical support components and incorporating PIC interface extrusions;

FIG. 74 illustrates a bottom right front perspective view of an exemplary HVAC duct structure constructed using the present invention EIS RCC and RAC vertical support components and incorporating PIC interface extrusions;

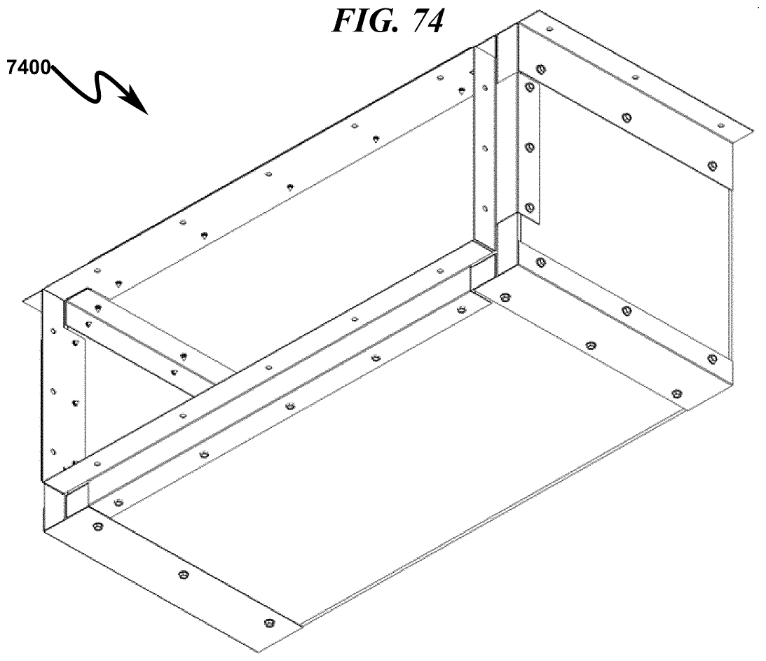

FIG. 75 illustrates a front view of an exemplary HVAC duct structure constructed using the present invention EIS RCC and RAC vertical support components and incorporating PIC interface extrusions;

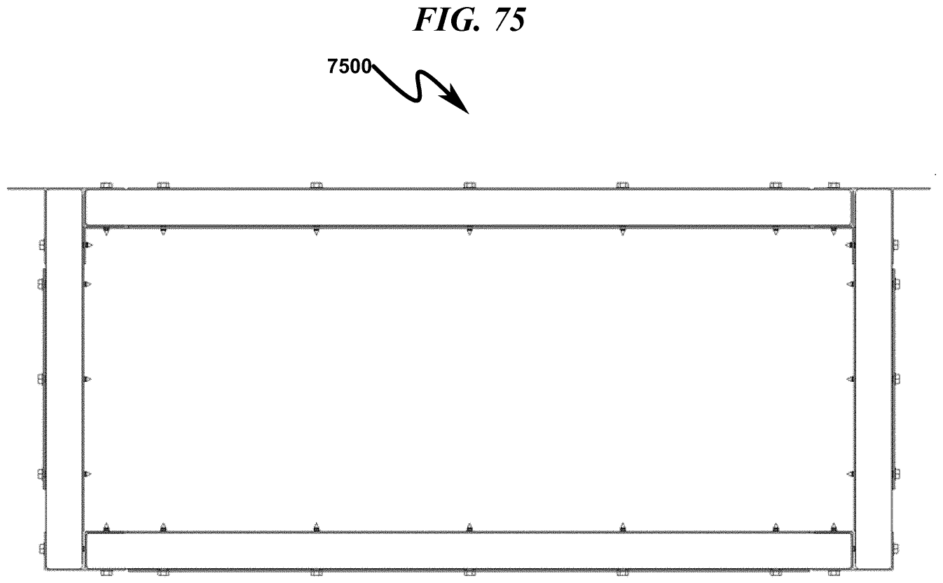

FIG. 76 illustrates a rear view of an exemplary HVAC duct structure constructed using the present invention EIS RCC and RAC vertical support components and incorporating PIC interface extrusions;

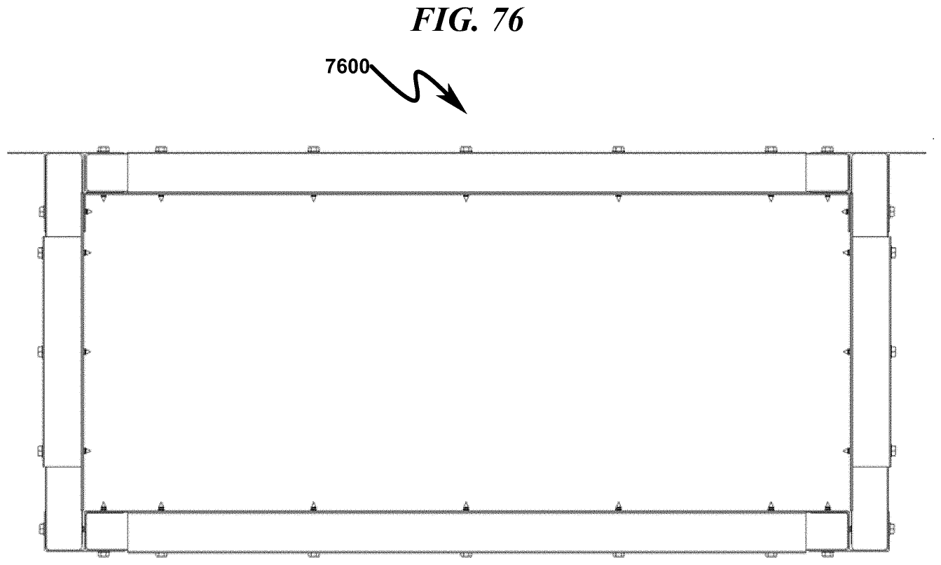

FIG. 77 illustrates a top view of an exemplary HVAC duct structure constructed using the present invention EIS RCC and RAC vertical support components and incorporating PIC interface extrusions;

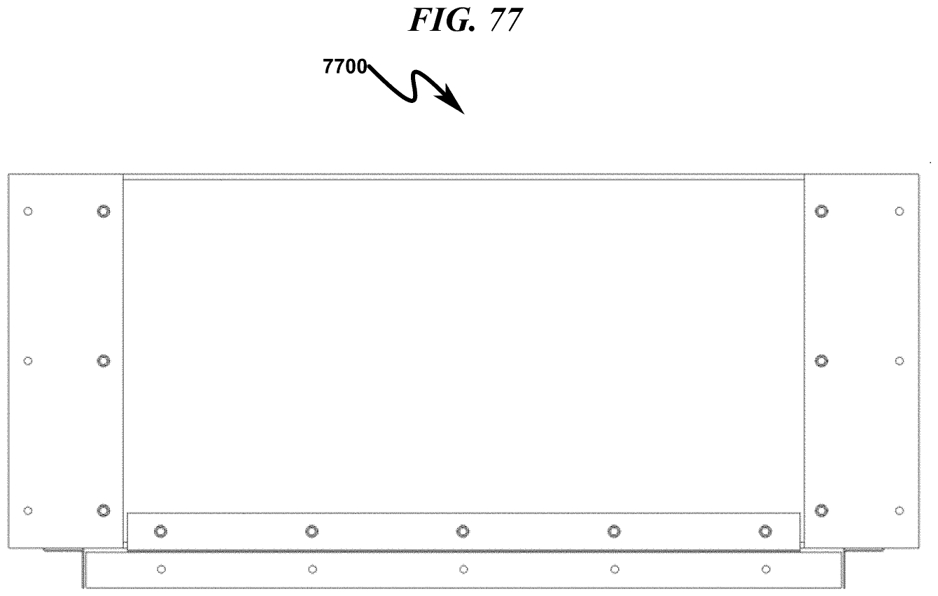

FIG. 78 illustrates a bottom view of an exemplary HVAC duct structure constructed using the present invention EIS RCC and RAC vertical support components and incorporating PIC interface extrusions;

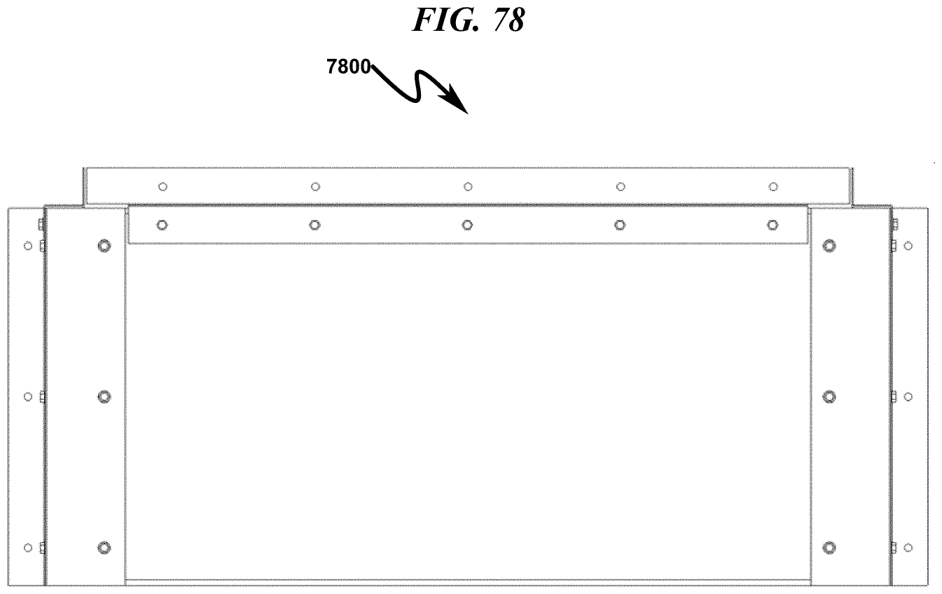

FIG. 79 illustrates a left side view of an exemplary HVAC duct structure constructed using the present invention EIS RCC and RAC vertical support components and incorporating PIC interface extrusions;

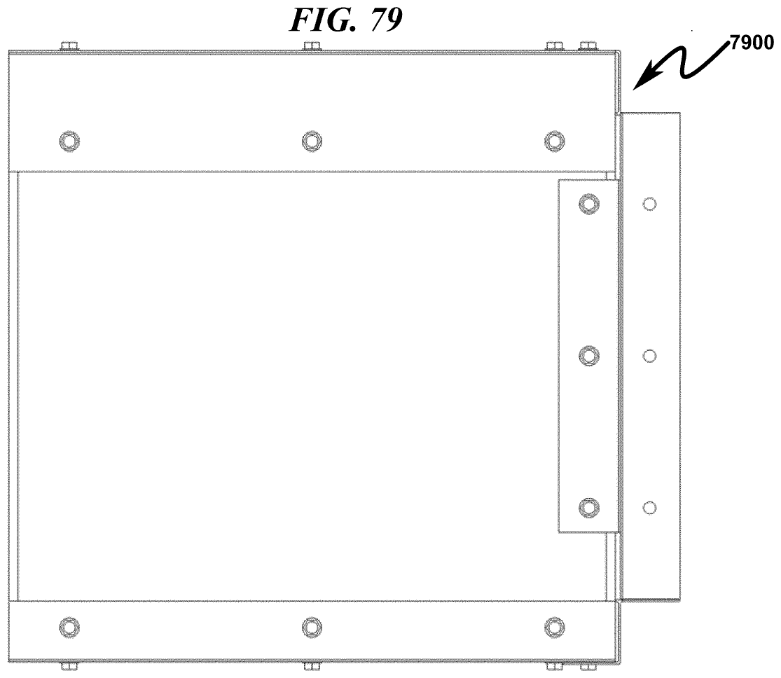

FIG. 80 illustrates a right side view of an exemplary HVAC duct structure constructed using the present invention EIS RCC and RAC vertical support components and incorporating PIC interface extrusions;

FIG. 81 illustrates a top right front perspective view of an exemplary HVAC duct structure constructed using the present invention EIS RCC and RAC horizontal support components and incorporating SIC interface extrusions;

FIG. 82 illustrates a bottom right front perspective view of an exemplary HVAC duct structure constructed using the present invention EIS RCC and RAC horizontal support components and incorporating SIC interface extrusions;

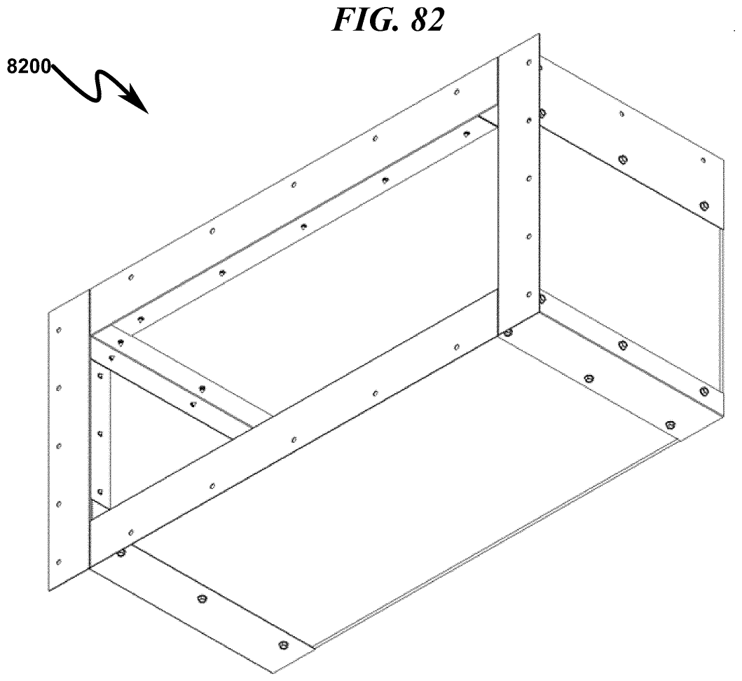

FIG. 83 illustrates a front view of an exemplary HVAC duct structure constructed using the present invention EIS RCC and RAC horizontal support components and incorporating SIC interface extrusions;

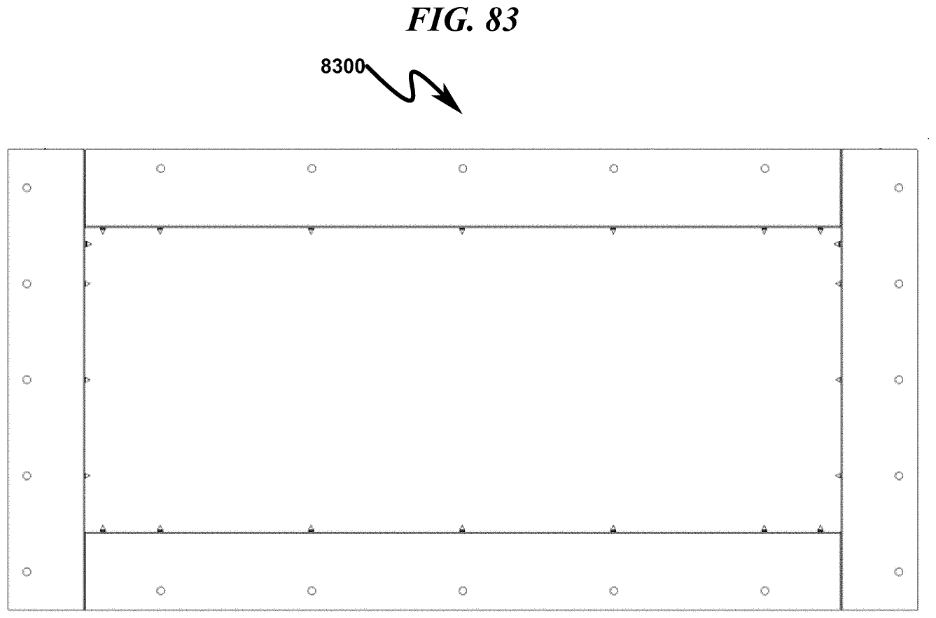

FIG. 84 illustrates a rear view of an exemplary HVAC duct structure constructed using the present invention EIS RCC and RAC horizontal support components and incorporating SIC interface extrusions;

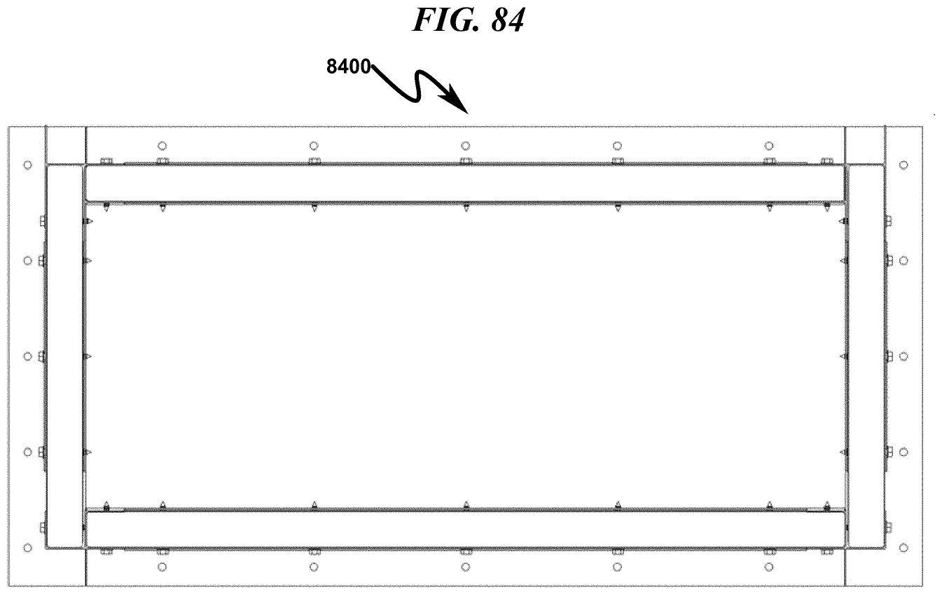

FIG. 85 illustrates a top view of an exemplary HVAC duct structure constructed using the present invention EIS RCC and RAC horizontal support components and incorporating SIC interface extrusions;

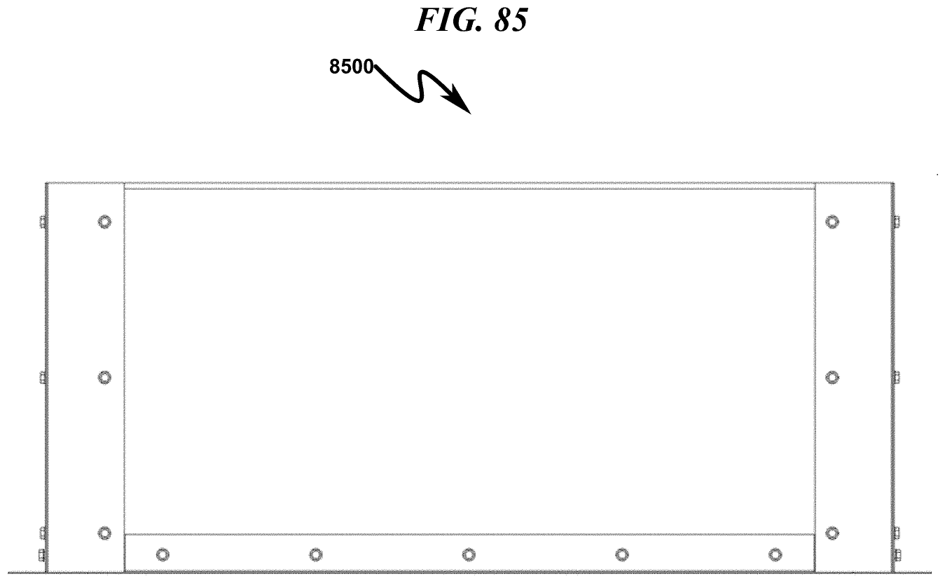

FIG. 86 illustrates a bottom view of an exemplary HVAC duct structure constructed using the present invention EIS RCC and RAC horizontal support components and incorporating SIC interface extrusions;

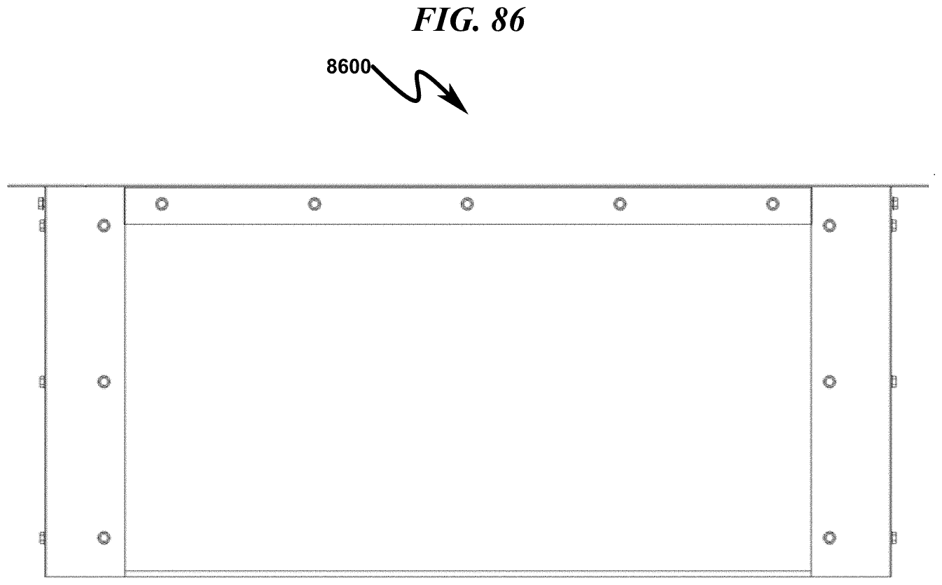

FIG. 87 illustrates a left side view of an exemplary HVAC duct structure constructed using the present invention EIS RCC and RAC horizontal support components and incorporating SIC interface extrusions;

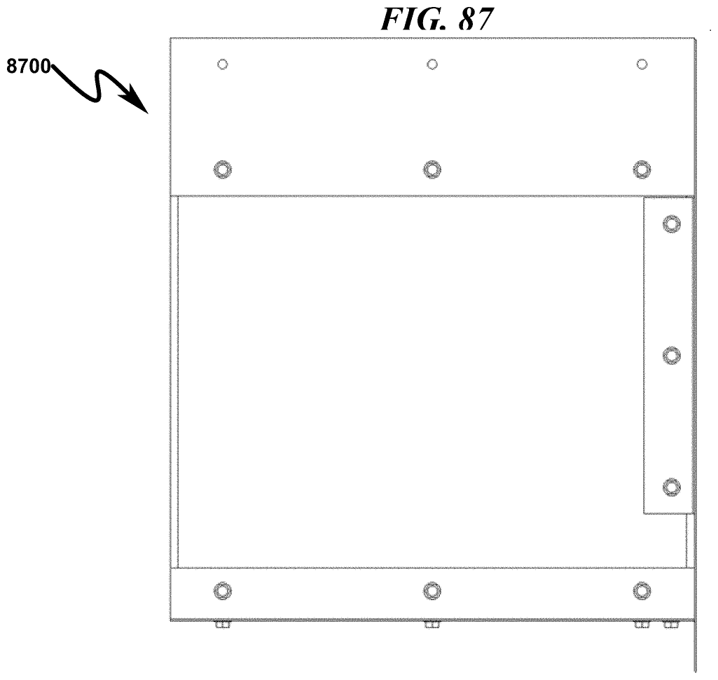

FIG. 88 illustrates a right side view of an exemplary HVAC duct structure constructed using the present invention EIS RCC and RAC horizontal support components and incorporating SIC interface extrusions;

FIG. 89 illustrates a side profile view of an exemplary edge sealed DBS linkage as applied to a DBS mated to a PSC EIS structure;

FIG. 90 illustrates a side profile view of an exemplary pinned DBS linkage as applied to a DBS mated to a PSC EIS structure;

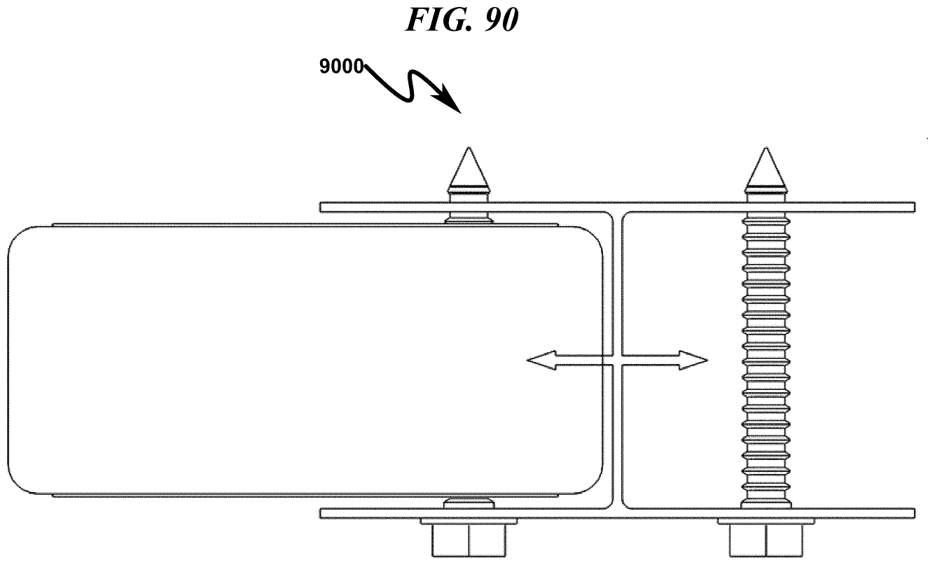

FIG. 91 illustrates a side profile view of an exemplary ridged DBS linkage as applied to a DBS mated to a PSC EIS structure;

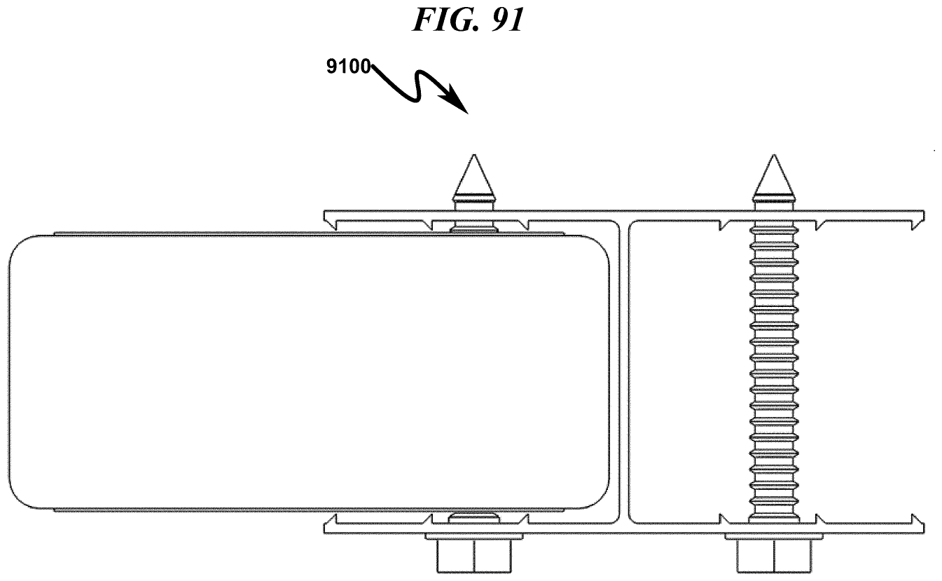

FIG. 92 illustrates a side profile view of an exemplary lobed DBS linkage as applied to a DBS mated to a PSC EIS structure;

FIG. 93 illustrates a perspective view of an exemplary PSC EIS embodiment incorporating sidewall draft;

FIG. 94 illustrates a profile side view of an exemplary PSC EIS embodiment incorporating sidewall draft;

FIG. 95 illustrates a perspective view of an exemplary PSC EIS embodiment incorporating sidewall thickness taper; and

FIG. 96 illustrates a profile side view of an exemplary PSC EIS embodiment incorporating sidewall thickness taper.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a DUCT BOARD SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Extrusion Material Not Limitive

The present invention utilizes specialized extruded edge interconnection strips (EIS) in the construction of duct board used in HVAC systems. While the present invention may make specific mention of polyvinyl chloride (PVC) extrusions, the present invention anticipates that a wide variety of materials may be used for these extrusions, including but not limited to polyethylene (PE), polypropylene, acetal, acrylic, nylon (polyamides), polystyrene, polyvinyl chloride (PVC), acrylonitrile butadiene styrene (ABS), polycarbonate, and metals such as aluminum, aluminum alloys, copper, copper alloys, steel, steel alloys, and galvanized sheet metal. In some circumstances the EIS may be fabricated using conventional sheet metal techniques with a variety of metal materials with galvanized steel being preferred.

### Sheet Metal Pathways Not Limitive

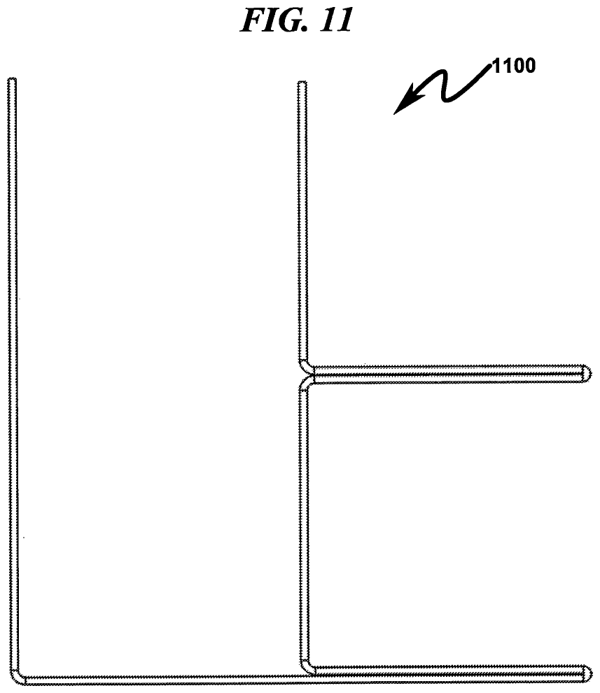

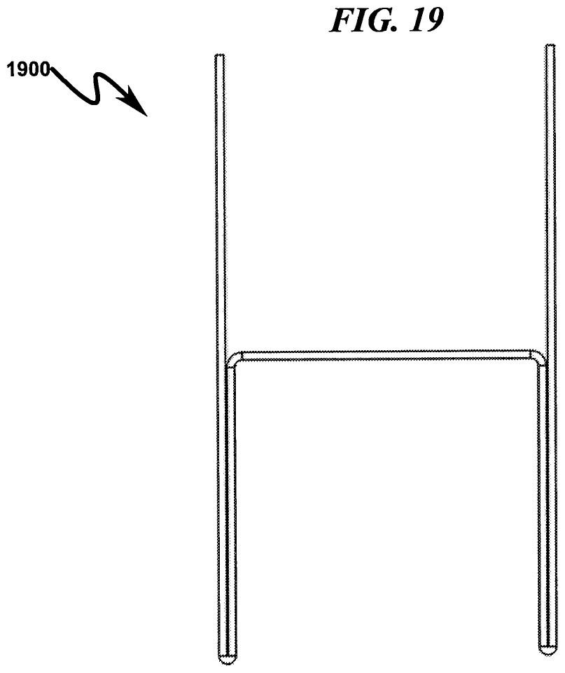

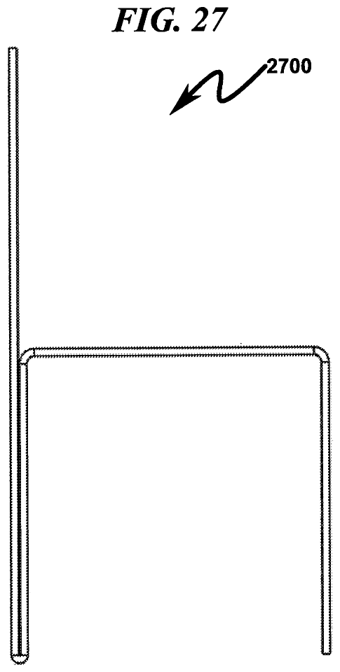

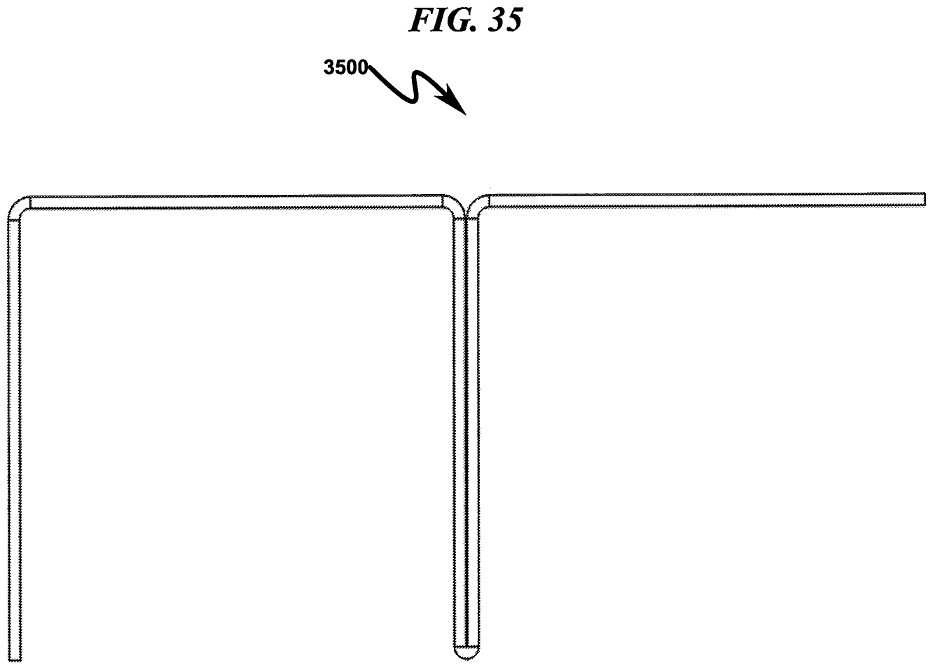

In some invention embodiments the extrusion profiles may be generated using conventional sheet metal fabrication techniques, wherein a sheet metal hem may be used to fabricate one wall segment of a particular extrusion structure. This technique is generally illustrated in FIG. 11 (1100), FIG. 19 (1900), FIG. 27 (2700), and FIG. 35 (3500). One skilled in the art will recognize that the sheet metal routing may take different forms wherein the sheet metal hems are placed at other segments within the extrusion outline. The present invention anticipates these variations and they are anticipated within the scope of the claimed invention. For brevity of presentation only a few of these exemplary sheet metal pathways are depicted with other variations within the scope of one skilled in the art to define.

### Normalized Extrusion Profile (NEP)

The present invention may be defined in terms of a number of extrusion profiles having substantially straight wall profiles. Within this context a coordinate system defining a Normalized Extrusion Profile (NEP) will be used to define segments that constitute these wall profiles. The format for the NEP coordinates will be in the form of segments such as [(x1,y1)-(x2,y2)] that imply a straight line segment extending from coordinate (X=x1 and Y=y1) to (X=x2 and Y=y2). Within this context coordinates that coincide will be considered as merged and may contain fillets or other manufacturing augmentations as desired by application context.

Furthermore, it should be noted that the profiles provided are normalized to UNITY32 1, with UNITY=1 being the nominal thickness of the duct board used in the application. It should be also noted that these normalized coordinates may be stretched or expanded to accommodate the extrusion wall thickness of the EIS. For example, a coordinate segment of [(0,0)-(1,0)] may define a bottom wall crossing the edge of a DBS in which segments of [(0,0)-(0,1)] and [(1,0)-(1,1)] form the sidewalls that capture the DBS. In this circumstance the NEP coordinates define only the side capture limits of the DBS and not the extent of the extrusion in which the actual extrusion coordinates would be enhanced to compensate for the extrusion wall thicknesses. Thus, the NEP coordinates provided may be used to define a generic extrusion profile that may be adjusted as needed for extrusion wall thickness as well as DBS thickness.

### Extrusion Orientation Not Limitive

The present invention will be presented in various preferred exemplary embodiment that incorporate a variety of extrusions and other structures. These EIS extrusions may be oriented in any direction in conjunction with suitably sized DBS to form a wide variety of HVAC duct assemblies. The particular orientation of the EIS is not limitive in these application contexts. This generalized orientation anticipation is particularly applicable to the RAC/RCC corner treatments in which the sidewall capture depth of the DBS may be different for each of the EIS DBS capture wells within the EIS.

### Extrusion Trimming Anticipated

The EIS structures depicted herein may be trimmed in the field for length and to provide for corner/interface treatments as needed based on application context. A significant feature of the present invention is the ability to trim the resulting HVAC duct structure to meet field sizing requirements without the need for removing the duct to a shop or other manufacturing facility. Often in installing HVAC ductwork the physical confines of the resulting duct is very space constrained and as such the ability to make slight modifications to the duct formation structure is highly desirable. Trimming of the EIS structures using tin snips or other suitable cutters is optimal in this situation as it is generally not possible to operate traditional duct board tooling in these confined construction spaces.

### Extrusion Sidewall Draft/Thickness Taper Anticipated

In some preferred invention embodiments the sidewalls of the EIS structure may incorporate sidewall draft as an aid in both manufacturing of the extrusion as well as fastening of the DBS within the confines of the EIS sidewalls. Thus, while the NEP profiles depicted herein contain perfectly vertical and horizontal sidewall structures, these structures when manufactured in some embodiments may be configured to contain a draft angle of arbitrary value based on application context (typically 10 degrees or less, but not limited to this range) in order to enhance manufacturability but also provide for grasping of the DBS within the sidewalls. Additionally, to enhance the strength of the sidewalls, there may exist a thickness taper along the sidewall face. One skilled in the art will quickly recognize that these two features (sidewall draft and thickness taper) may be combined in a number of ways to enhance both manufacturability as well as attachment of the EIS to the DBS.

### DBS Thickness Not Limitive

Duct board sheet (DBS) material is typically fabricated with a planar insulating core material (typically compressed fiberglass) that is covered with a vapor barrier material such as aluminum or alternatively a non-metallic vapor barrier material. DBS is typically available in nominal thicknesses of 0.5-inch, 1.0-inch, 1.5-inch, and 2.0-inches. The present invention scope is not limited to any particular DBS thickness and the use of Normalized Extrusion Profile (NEP) coordinates in the description of the present invention allows the present invention to be adopted to any range of DBS thickness.

### Sheet Metal Hems

The present invention in some embodiments may be implemented using formed sheet metal. In these circumstances one or more sheet metal hems may be used in the formation of the EIS. These sheet metal hems may in some circumstances be spot welded to form a unitary hem structure.

### Spaced Fastener Connections

The EIS described herein whether extruded or formed may incorporate provisions for spaced fastener connections. These holes are typically uniformly spaced along the EIS but may be positioned in predetermined positions. Typically, a spacing of 8 inches between holes is normally sufficient to provide for attachment of the EIS to the duct board using self-tapping screw fasteners. A preferred screw fastener is a #8 hex head washer self tapping screw.

The spaced fastener connections may be configured for uniform sizing (such as a #8 clearance hole for use with a #8 fastener), or in some circumstances may be configured as a fastener clearance hole on one inside surface of the extrusion and a smaller non-clearance hole on the other (opposite) inside surface of the extrusion.

### System Overview (0700)-(0800)

The present invention anticipates that HVAC ducts may be created by simply cutting DBS with conventional cutters/saws and then assembling the HVAC duct using a variety of EIS extrusions to connect the pre-cut DBS sheets into the desired HVAC duct structure. This approach allows the HVAC duct to be quickly customized in the field without the need for special tooling and also in many cases integrates supports that allow the HVAC duct to be supported/hung within the confines of the air plenum environment. In many cases this assembly process takes place within spatially confined spaces and as such the ability to fabricate the HVAC duct in these environments is a distinct advantage over the use of conventional duct board fabrication techniques.

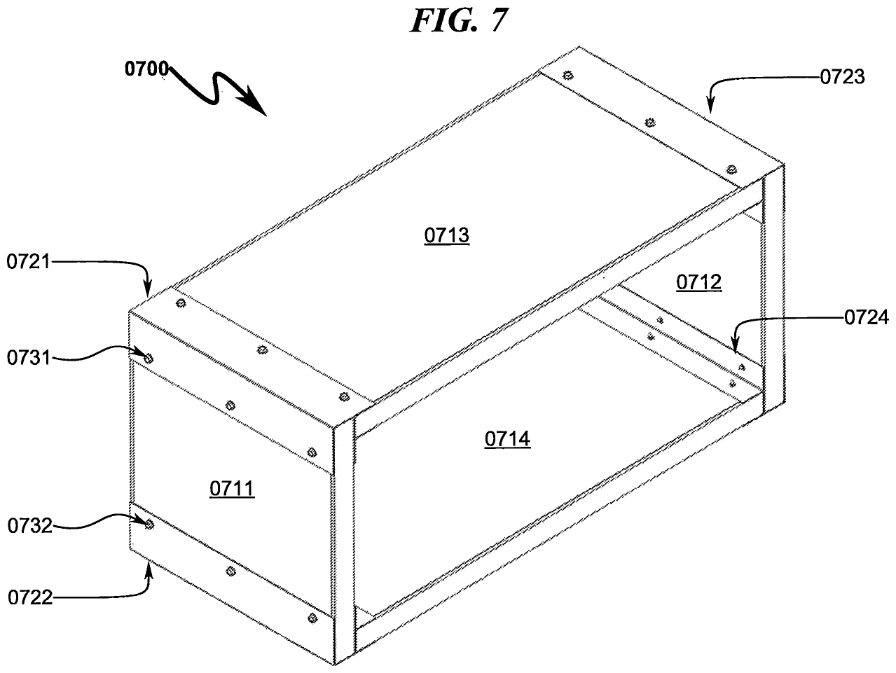

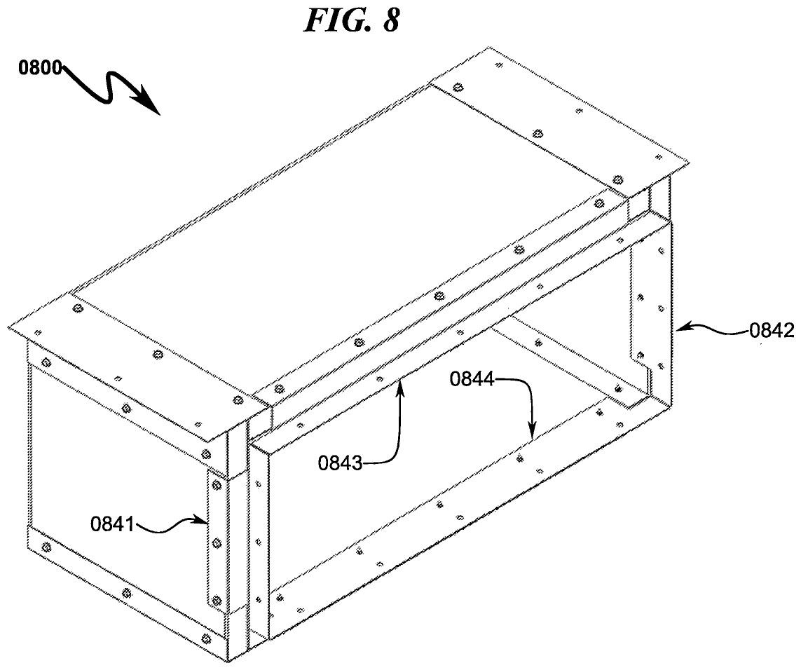

A typical HVAC duct created using the present invention teachings is generally depicted in FIG. 7 (0700) wherein DBS sheets (0711, 0712, 0713, 0714) form a HVAC duct and are retained in this form using extruded edge interconnection strips (EIS) (0721, 0722, 0723, 0724) in conjunction with appropriately spaced screw fasteners (0731, 0732). While the EIS illustrated in FIG. 7 (0700) depicts a right angle corner (RAC) EIS embodiment, other EIS forms are anticipated as generally depicted in FIG. 8 (0800) wherein the end treatment of the HVAC duct EIS takes the form of a planar interface connection (PIC) (0841, 0842, 0843, 0844) EIS configuration that permits the HVAC duct to be mated to some existing HVAC air containment structure. As indicated here the EIS structures depicted may be trimmed as necessary or in some cases overlapped to sandwich the DBS when constructing the HVAC duct structure.

### Right Angle Corner (RAC/RCC) EIS (0900)-(1600)

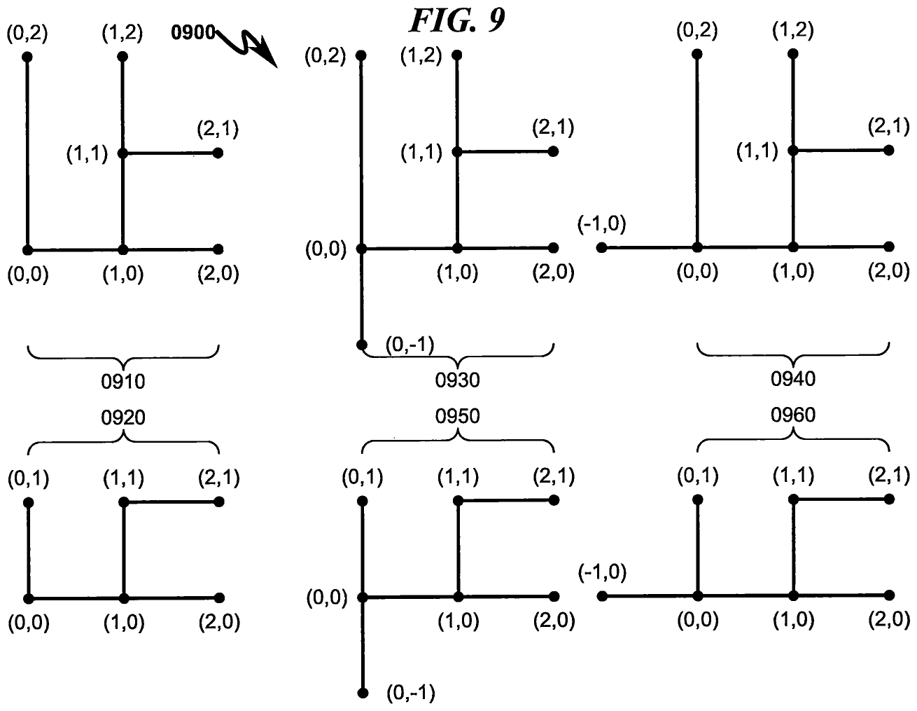

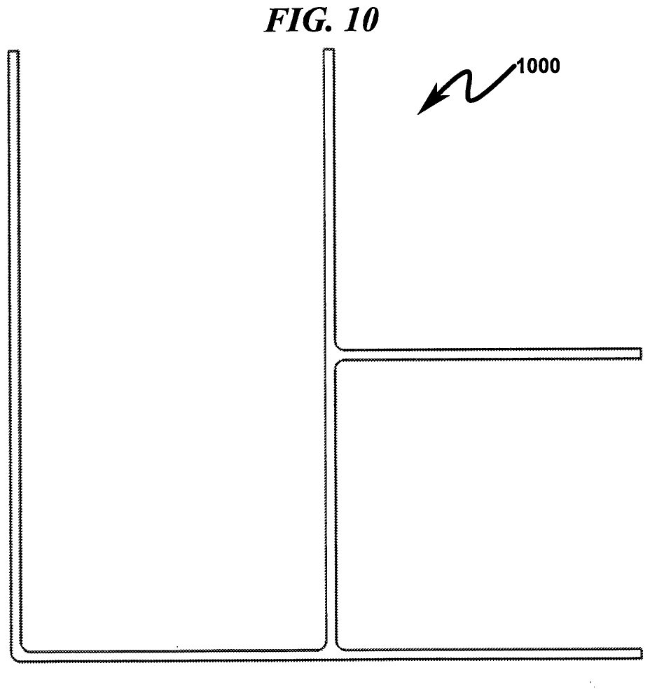

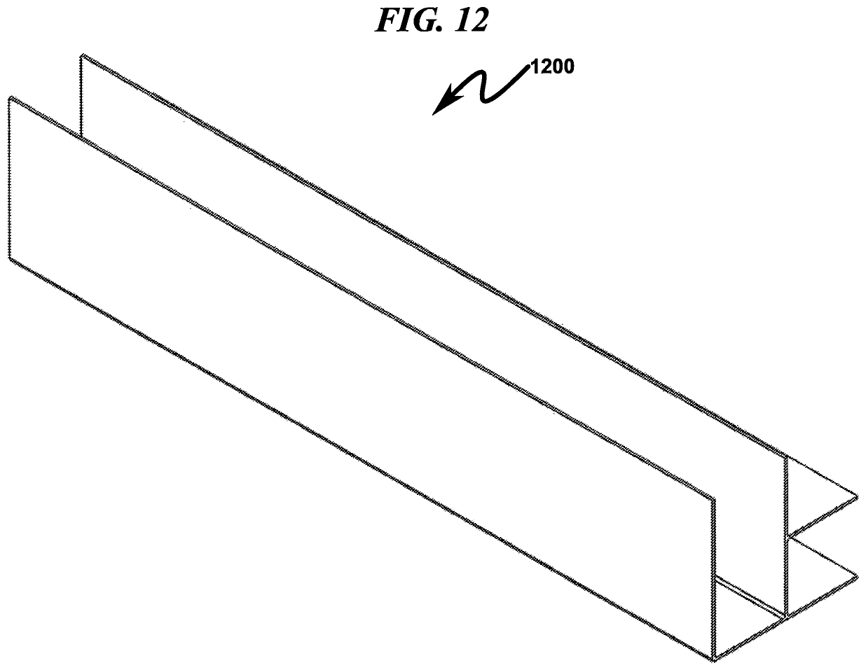

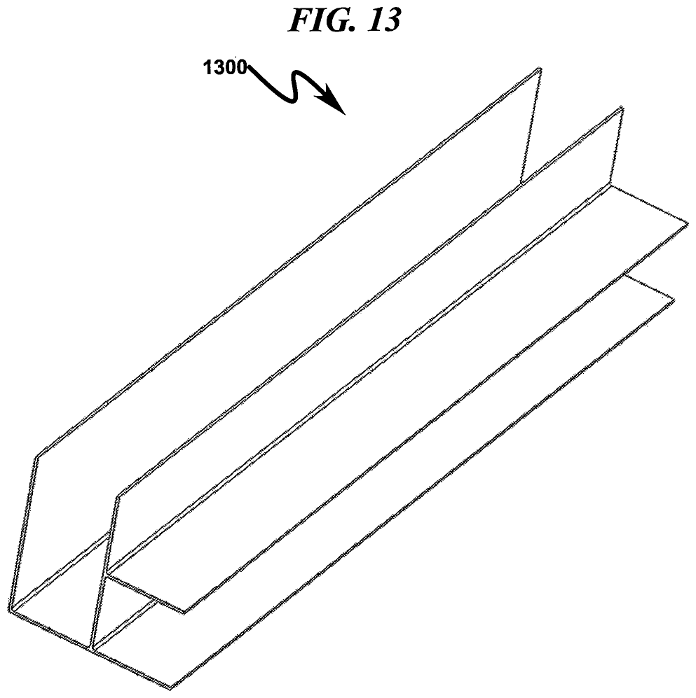

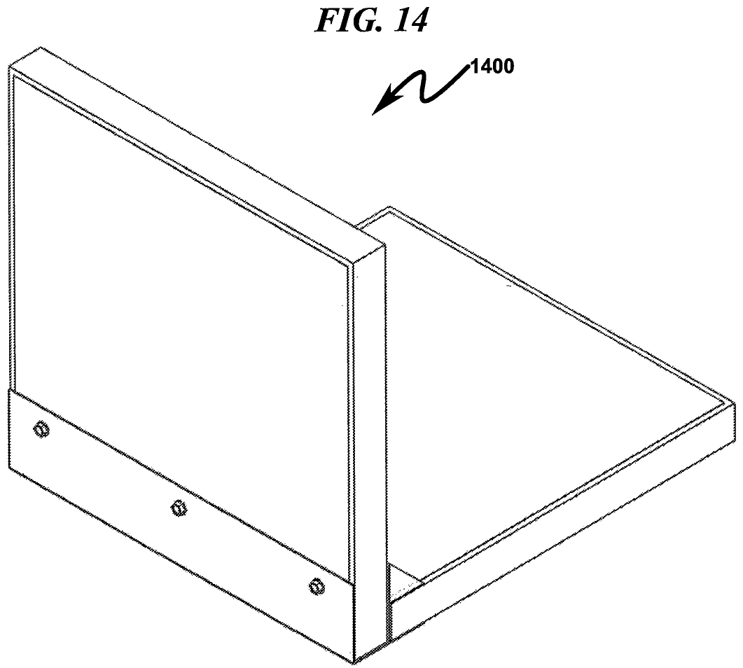

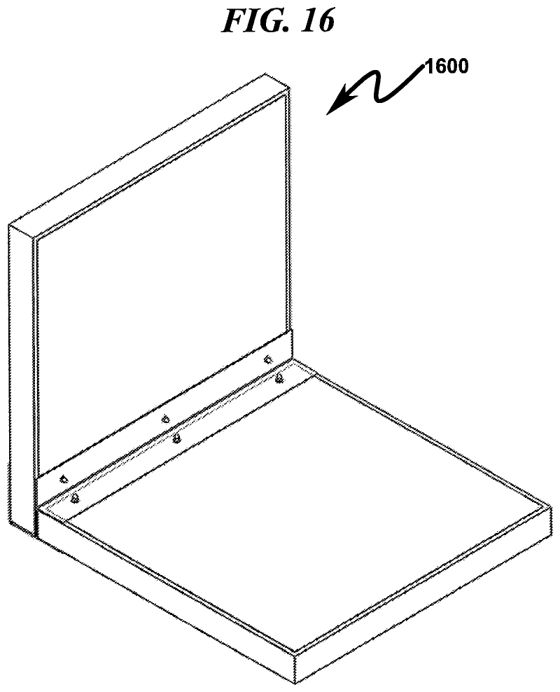

The present invention may be implemented as a right angle corner (RAC) EIS as generally depicted in FIG. 9 (0900)-FIG. 16 (1600). These normalized extrusion profiles is depicted in FIG. 9 (0900) (0910, 0920, 0930, 0940, 0950, 0960) and variant (0910) depicted in the side view of FIG. 10 (1000) using nominal extrusion wall thicknesses. These EIS may alternatively be implemented in formed sheet metal as depicted in the (0910) side view of FIG. 11 (1100). Perspective views of a typical EIS extrusion variant (0910) are depicted in FIG. 12 (1200) and FIG. 13 (1300). FIG. 14 (1400)-FIG. 16 (1600) depict the RAC EIS (0910) variant as typically assembled with duct board using screw fasteners.

FIG. 9 (0900) depicts a RAC compact (RCC) normalized extrusion profile (0920) that may be useful in some application contexts. Additional normalized extrusion profiles (0930, 0940, 0950, 0960) are also shown in which an additional segments [(0,0),(0,−1)] or [(0,0),(−1,0)] may be added to provide for hanging flanges that may be utilized to vertically suspend assembled ductwork using galvanized pipe strap (typically configured as 22-gauge×0.75-inch galvanized metal perforated plumbers tape), threaded rod (“all-thread”), or other suitable fastening means. These extrusion profiles may be used in any combination and are typically configured to provide a means for hanging the HVAC duct from an interior ceiling or plenum tie point.

### Planar Sheet Connection (PSC) EIS (1700)-(2400)

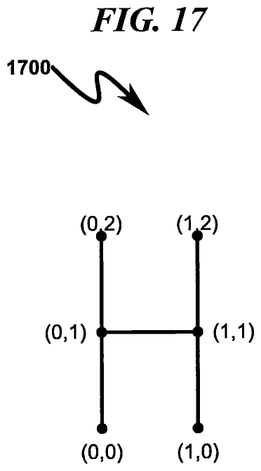

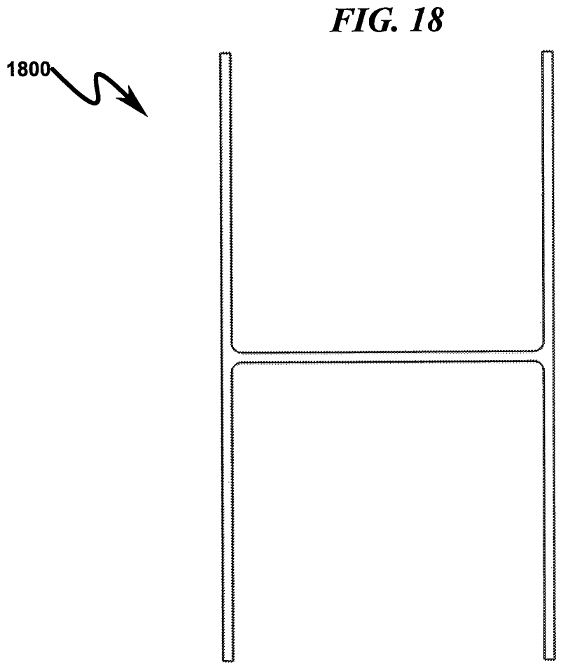

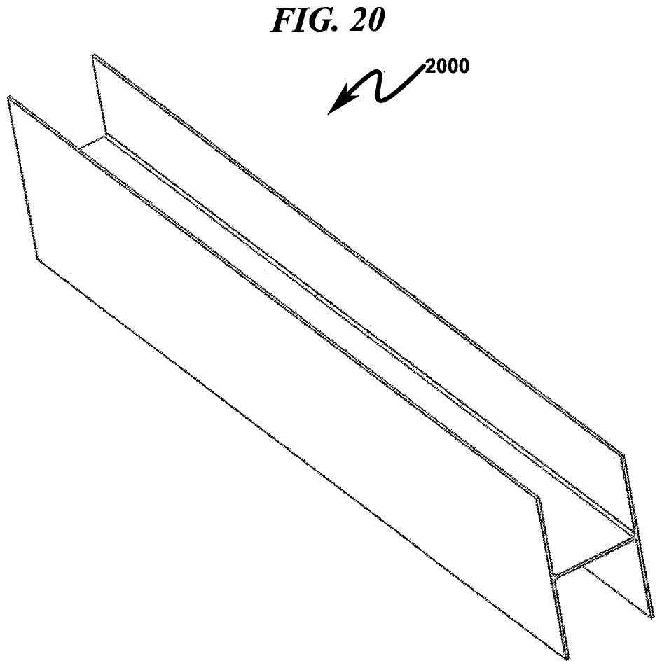

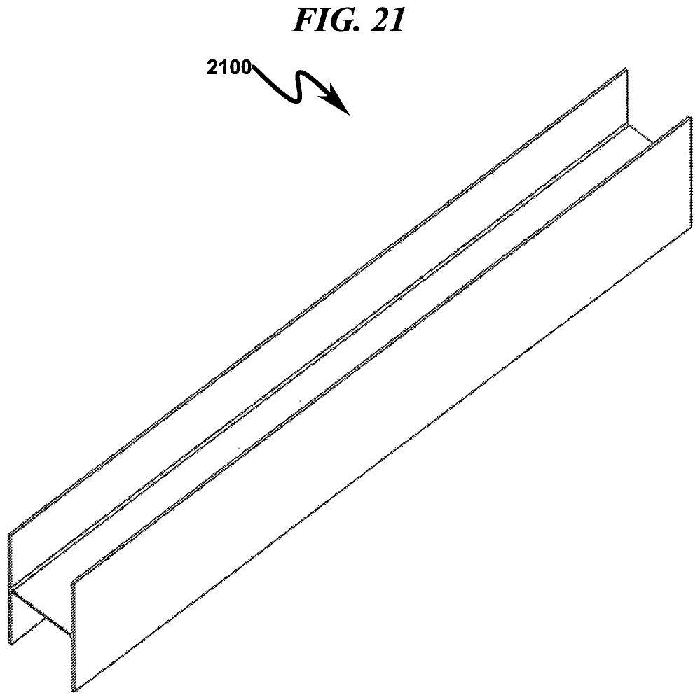

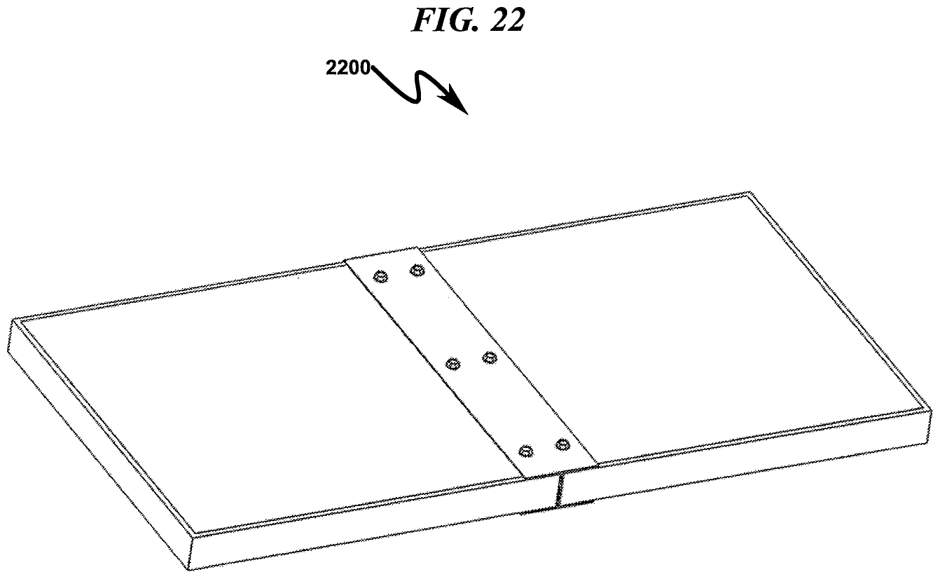

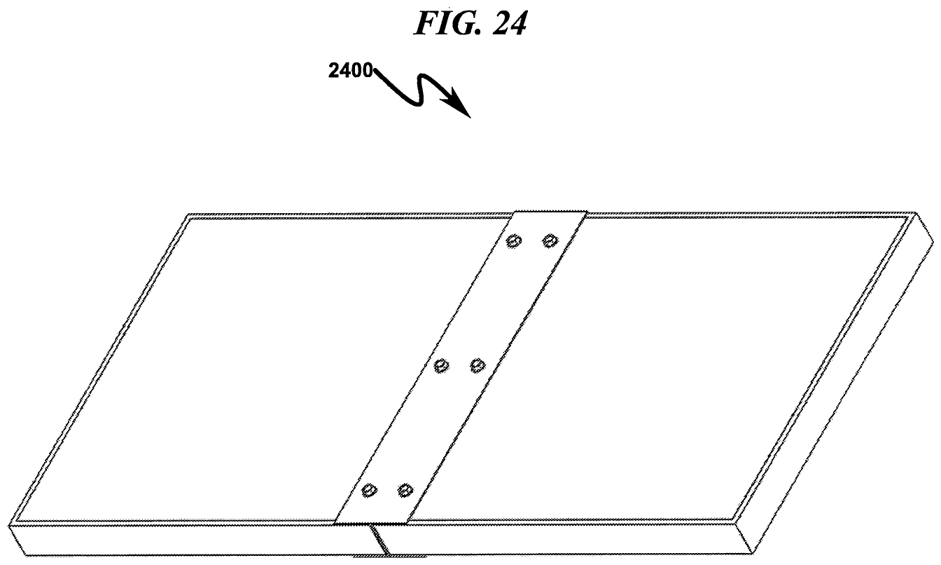

The present invention may be implemented as a planar sheet connection (PSC) EIS as generally depicted in FIG. 17 (1700)-FIG. 24 (2400). The normalized extrusion profile is depicted in FIG. 17 (1700) and is depicted in the side view of FIG. 18 (1800) using nominal extrusion wall thicknesses. This EIS may alternatively be implemented in formed sheet metal as depicted in the side view of FIG. 19 (1900). Perspective views of a typical EIS extrusion are depicted in FIG. 20 (2000) and FIG. 21 (2100). FIG. 22 (2200)-FIG. 24 (2400) depict the PSC EIS as typically assembled with duct board using screw fasteners.

### Planar Interface Connection (PIC) EIS (2500)-(3200)

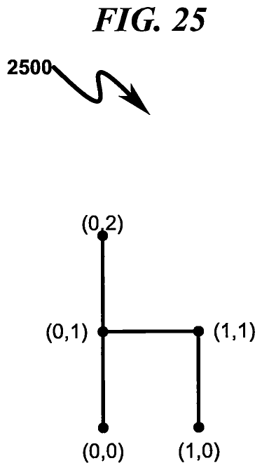

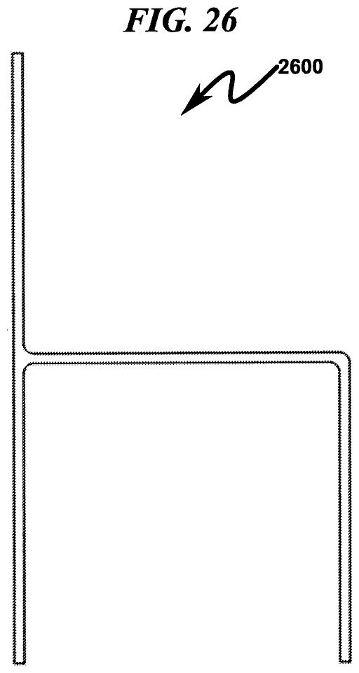

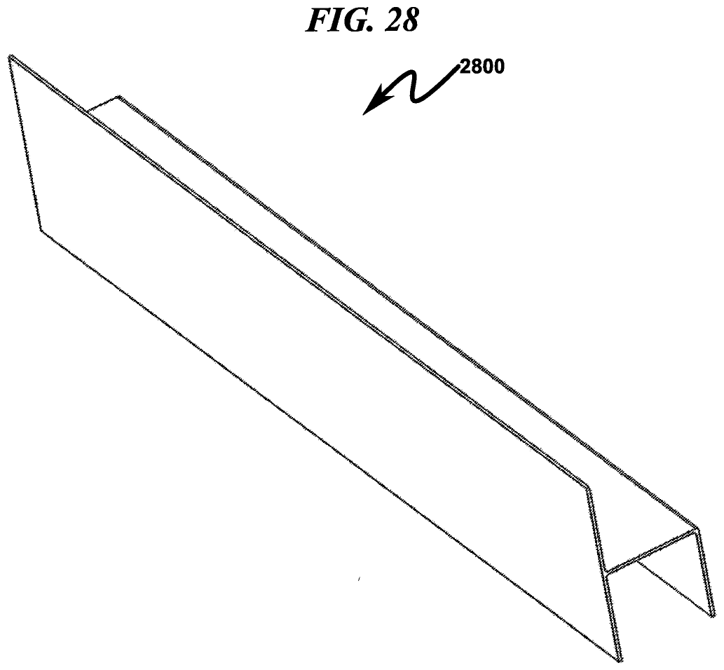

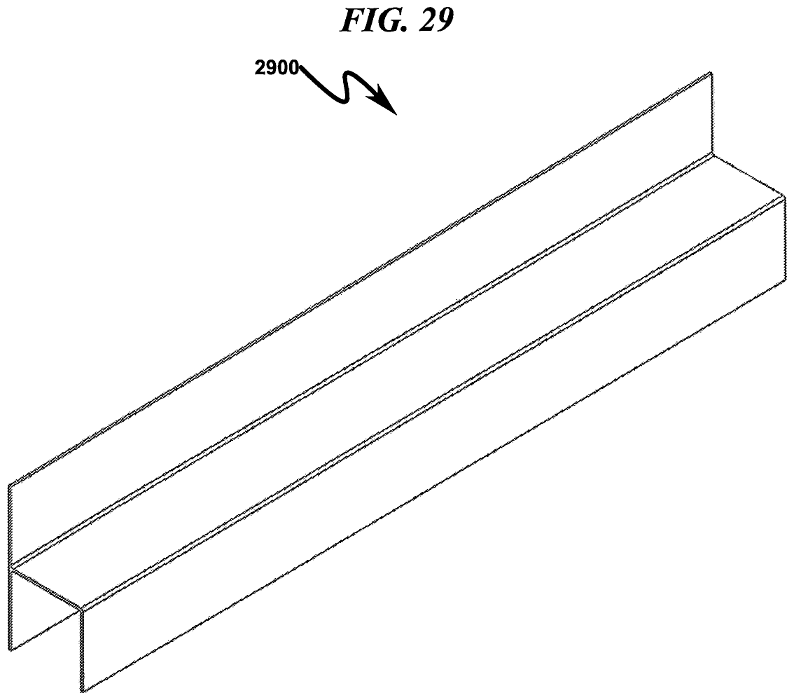

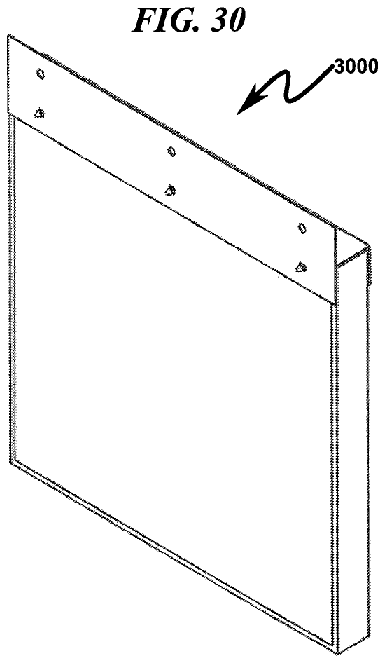

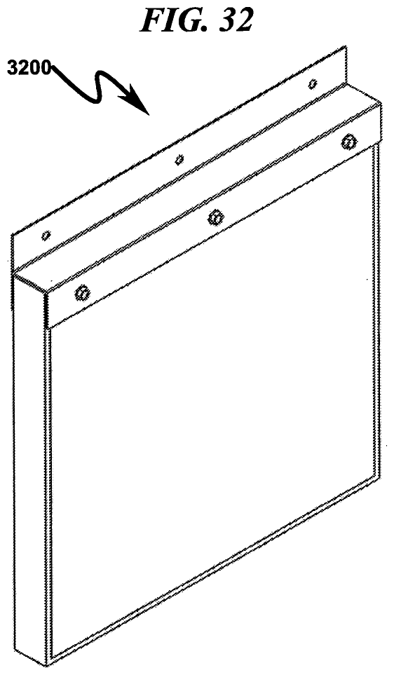

The present invention may be implemented as a planar interface connection (PIC) EIS as generally depicted in FIG. (2500)-FIG. 32 (3200). The normalized extrusion profile is depicted in FIG. 25 (2500) and is depicted in the side view of FIG. 26 (2600) using nominal extrusion wall thicknesses. This EIS may alternatively be implemented in formed sheet metal as depicted in the side view of FIG. 27 (2700). Perspective views of a typical EIS extrusion are depicted in FIG. 28 (2800) and FIG. 29 (2900). FIG. 30 (3000)-FIG. 32 (3200) depict the PIC EIS as typically assembled with duct board using screw fasteners.

### Surface Interface Connection (SIC) EIS (3300)-(4000)

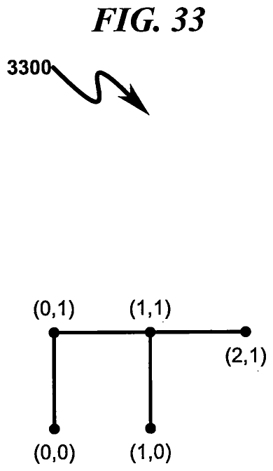

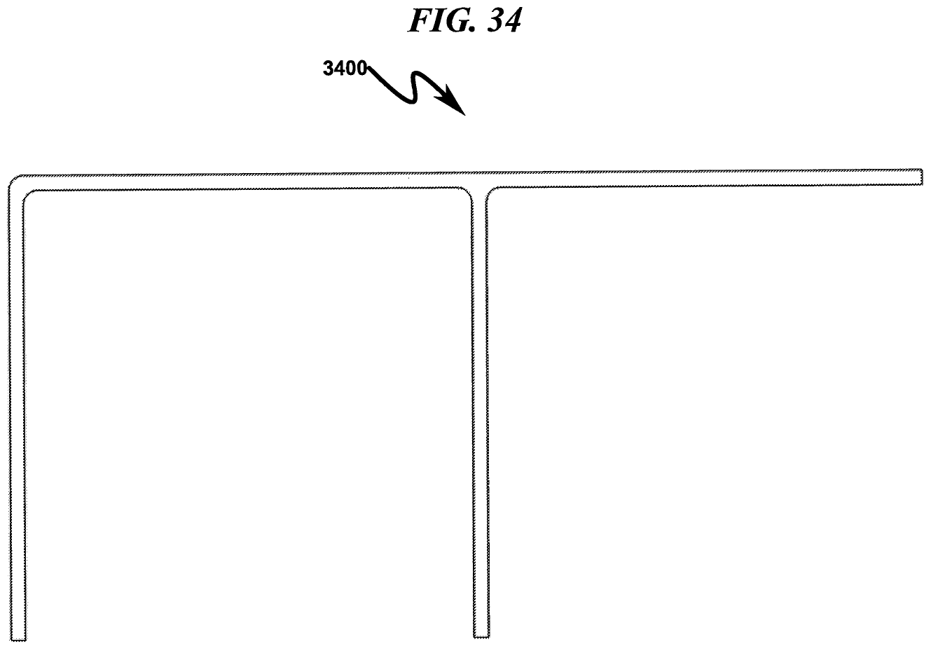

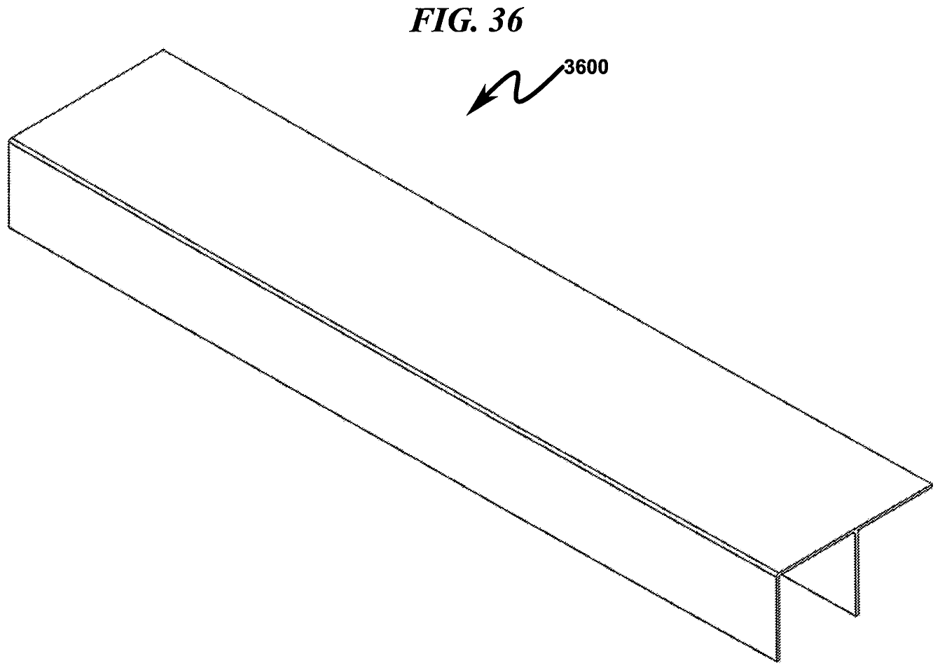

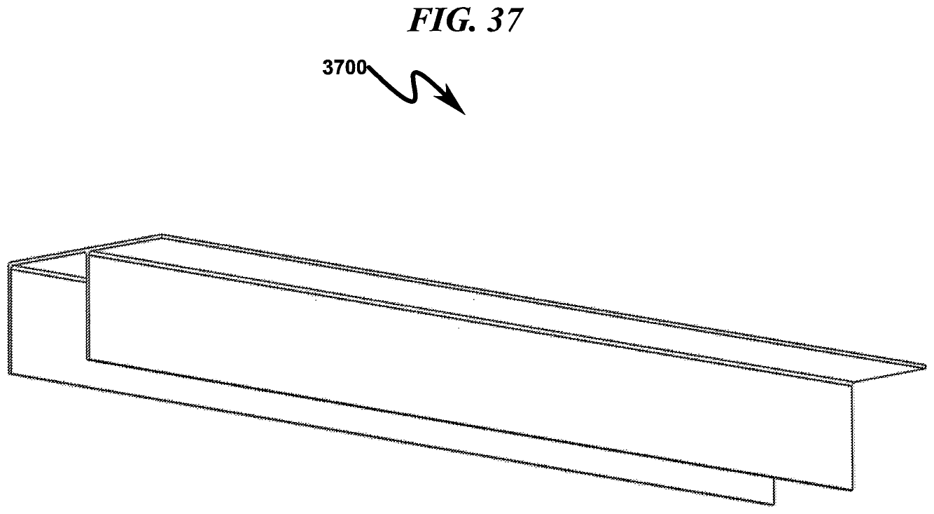

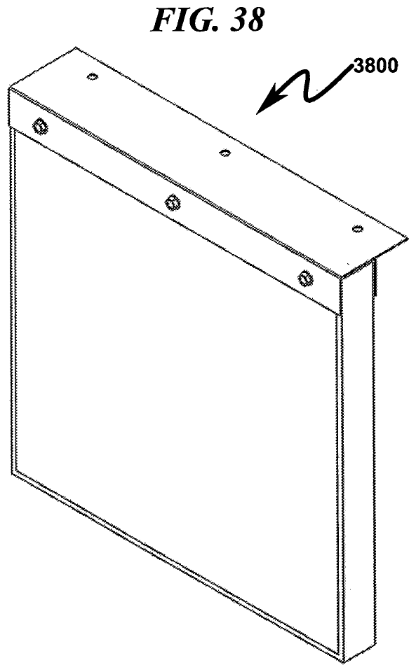

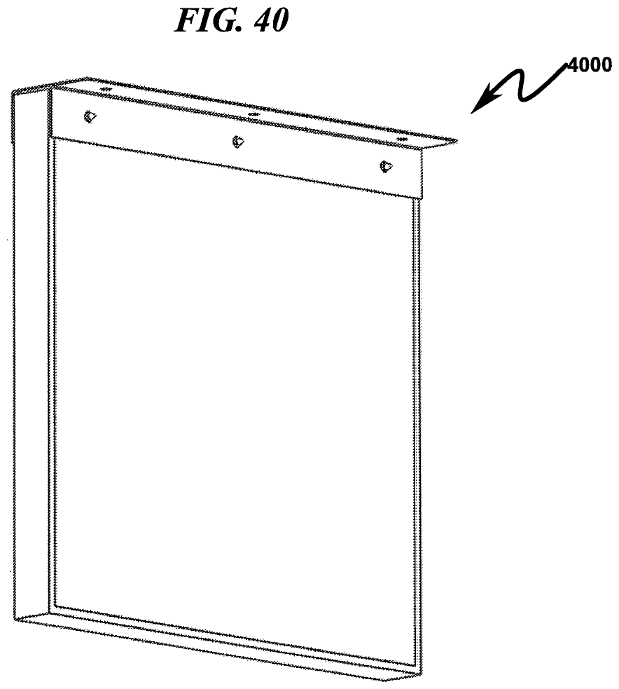

The present invention may be implemented as a surface interface connection (SIC) EIS as generally depicted in FIG. 33 (3300)-FIG. 40 (4000). The normalized extrusion profile is depicted in FIG. 33 (3300) and is depicted in the side view of FIG. 34 (3400) using nominal extrusion wall thicknesses. This EIS may alternatively be implemented in formed sheet metal as depicted in the side view of FIG. 35 (3500). Perspective views of a typical EIS extrusion are depicted in FIG. 36 (3600) and FIG. 37 (3700). FIG. 38 (3800)-FIG. 40 (4000) depict the SIC EIS as typically assembled with duct board using screw fasteners.

### EIS Fastener Connections (4100)-(4400)

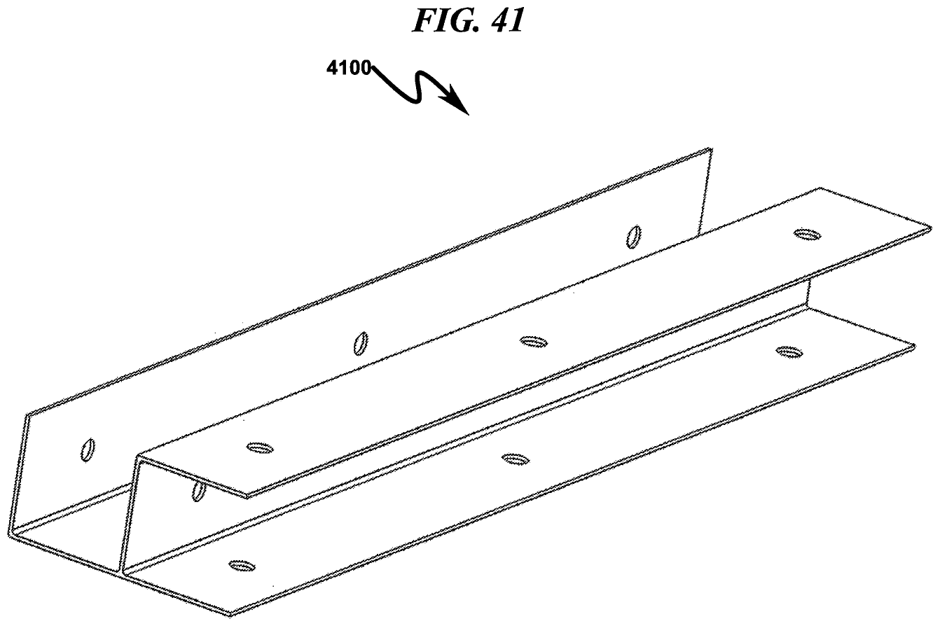

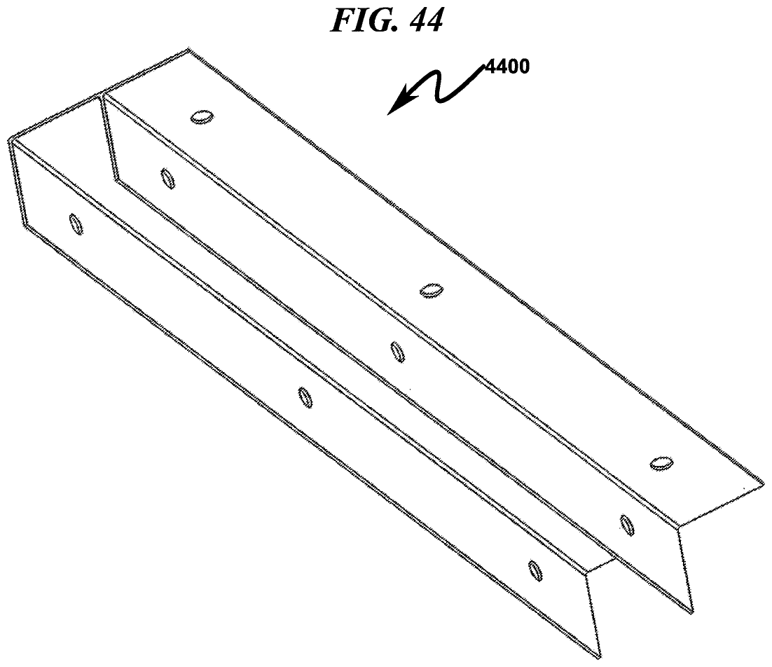

The present invention anticipates that the EIS structures may incorporate spaced holes to allow the DBS to be fixed to the EIS via the use of self-tapping screws (such as a #8 or #10 hex flange self-tapping screw). Some variations on this attachment methodology are generally depicted in FIG. 41 (4100)-FIG. 44 (4400). As noted previously, the spaced fastener connections may be configured for uniform sizing (such as a #8 clearance hole for use with a #8 fastener), or in some circumstances may be configured as a fastener clearance hole on one inside surface of the extrusion and a smaller non-clearance hole on the other (opposite) inside surface of the extrusion. This alternate configuration allows the screw fastener to completely penetrate the DBS and mate to both side walls of the EIS that sandwich the DBS, with the distal end of the screw fastener creating a self-threaded enlargement of the retaining (reduced size) mounting hole in the EIS.

### Edge Sealed DBS Linkage (4500)

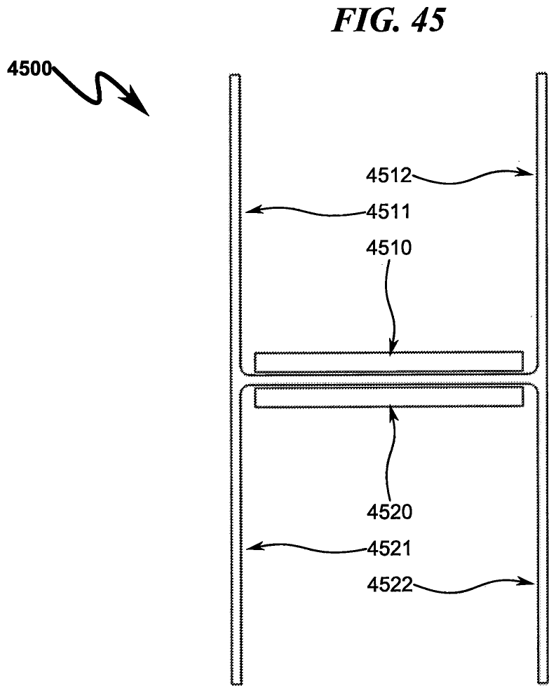

Some invention embodiments may employ an edge sealed DBS linkage as generally depicted in FIG. 45 (4500). Here a PSC EIS structure is shown that has been augmented with double-sided tape (4510, 4520) that is used to seal the edge of the DBS as it is inserted within the sidewalls (4511, 4512, 4521, 4522) of the EIS. This edge sealed DBS linkage may be employed at the base of the EIS DBS capture area within the EIS sidewalls in any of the EIS structures described herein.

### Pinned DBS Linkage (4600)

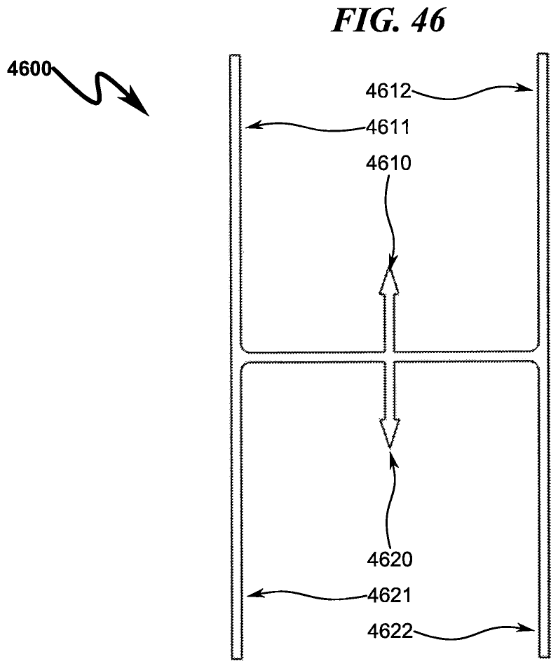

Some invention embodiments may employ pin sealed DBS linkage as generally depicted in FIG. 46 (4600). Here a PSC EIS structure is shown that has been augmented with an internal pin structure (4610, 4620) that is used to affix the edge of the DBS as it is inserted within the sidewalls (4611, 4612, 4621, 4622) of the EIS. This pin sealed DBS linkage may be employed at the base of the EIS DBS capture area within the EIS sidewalls in any of the EIS structures described herein.

### Ridged DBS Linkage (4700)

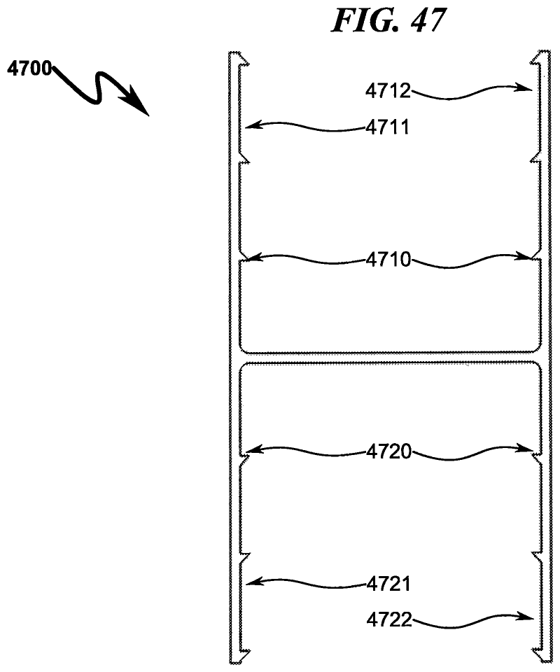

Some invention embodiments may employ a ridged sidewall DBS linkage as generally depicted in FIG. 47 (4700). Here a PSC EIS structure is shown that has been augmented with an internal ridge structure (4710, 47200) that is used to affix the sidewalls of the DBS as it is inserted within the sidewalls (4711, 4712, 4721, 4722) of the EIS. This structure also provides for a degree of sealing action between the EIS and the DBS. This ridged sidewall DBS linkage may be employed within the EIS sidewalls in any of the EIS structures described herein.

### Lobed DBS Linkage (4800)

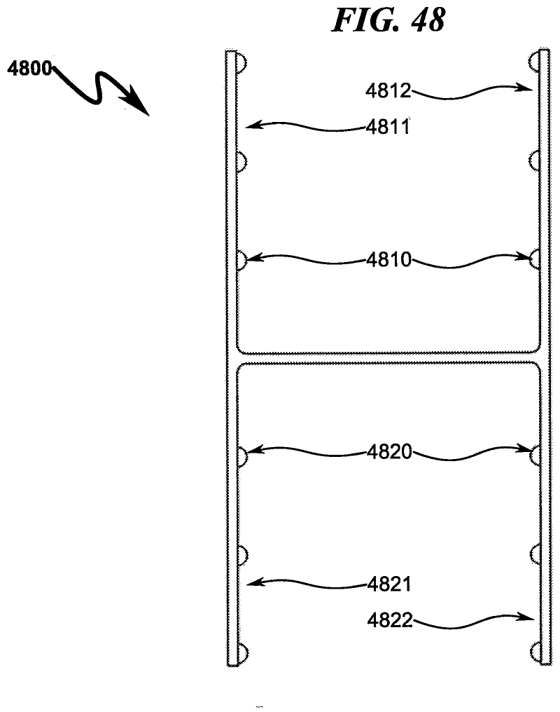

Some invention embodiments may employ a lobed sidewall DBS linkage as generally depicted in FIG. 48 (4800). Here a PSC EIS structure is shown that has been augmented with an internal lobed structure (4810, 4820) that is used to affix the sidewalls of the DBS as it is inserted within the sidewalls (4811, 4812, 4821, 4822) of the EIS. This structure also provides for a degree of sealing action between the EIS and the DBS. This lobed sidewall DBS linkage may be employed within the EIS sidewalls in any of the EIS structures described herein.

### EIS Hangar Clips (4900)-(5600)

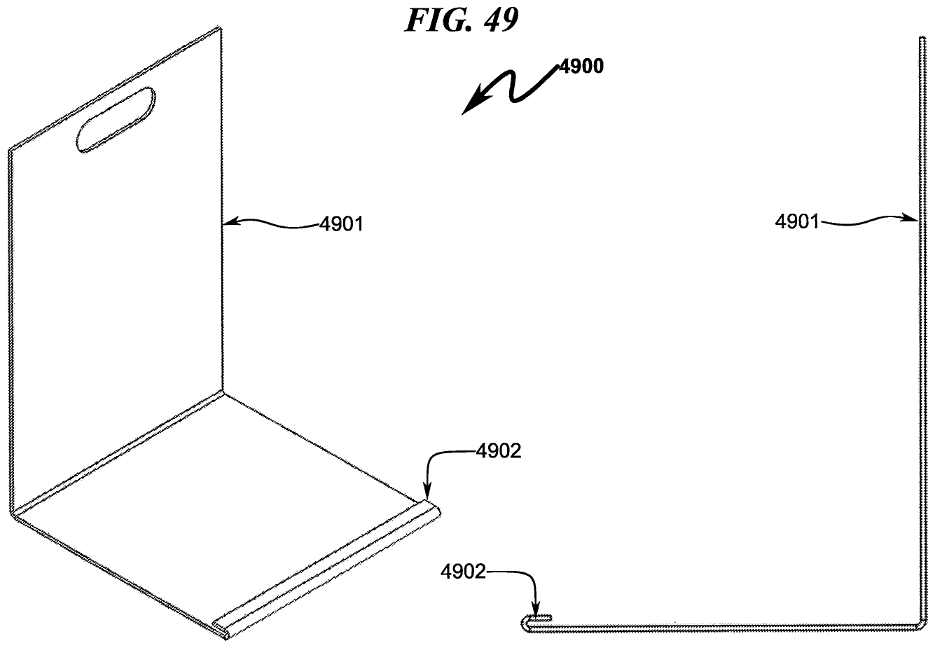

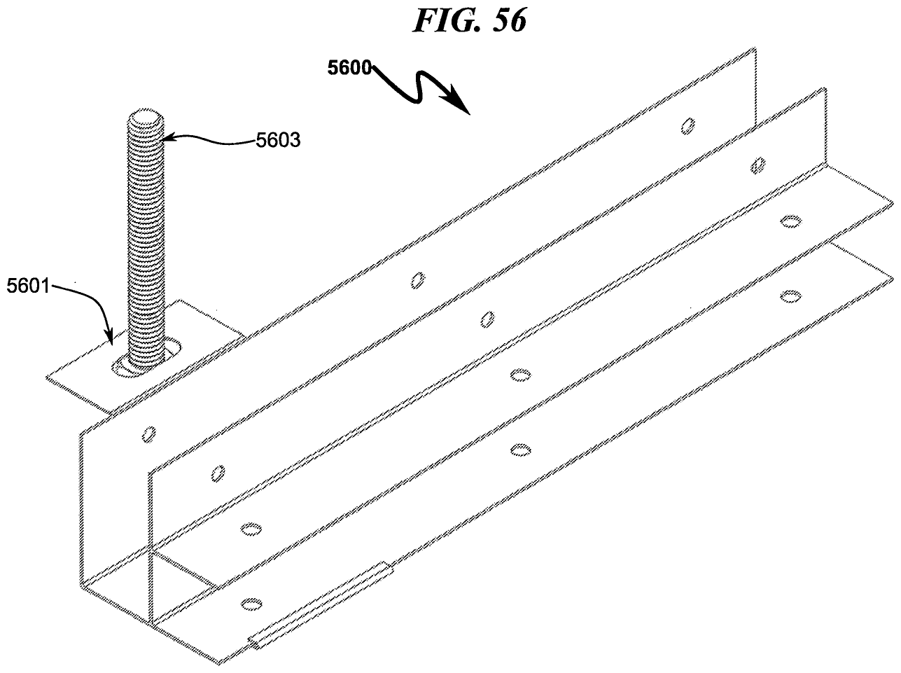

In various embodiments, the EIS structures in conjunction with attached DBS may be supported vertically via the use of a variety of hangar clips as generally depicted in FIG. 49 (4900)-FIG. 56 (5600).

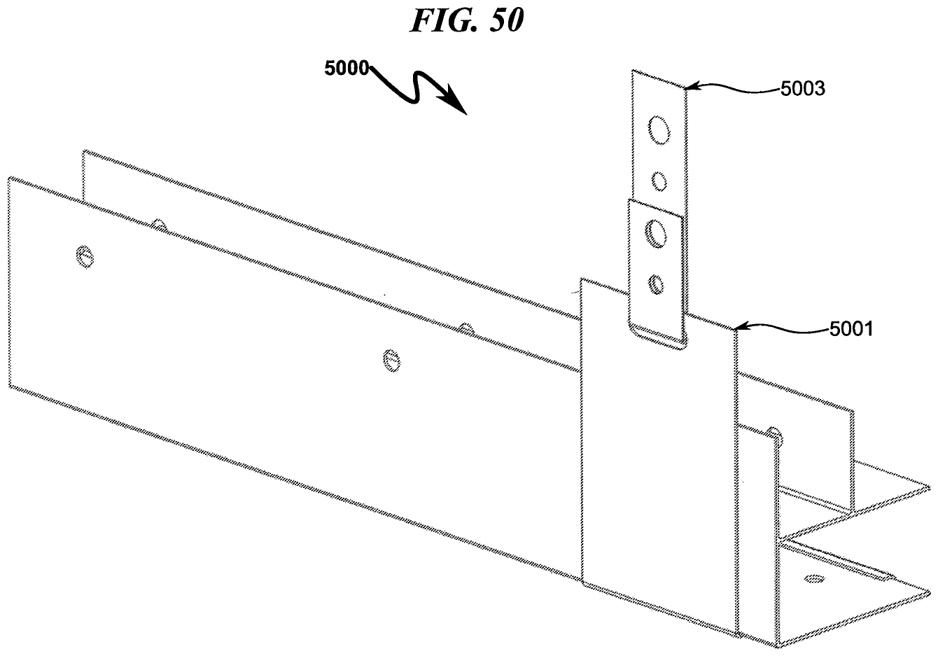

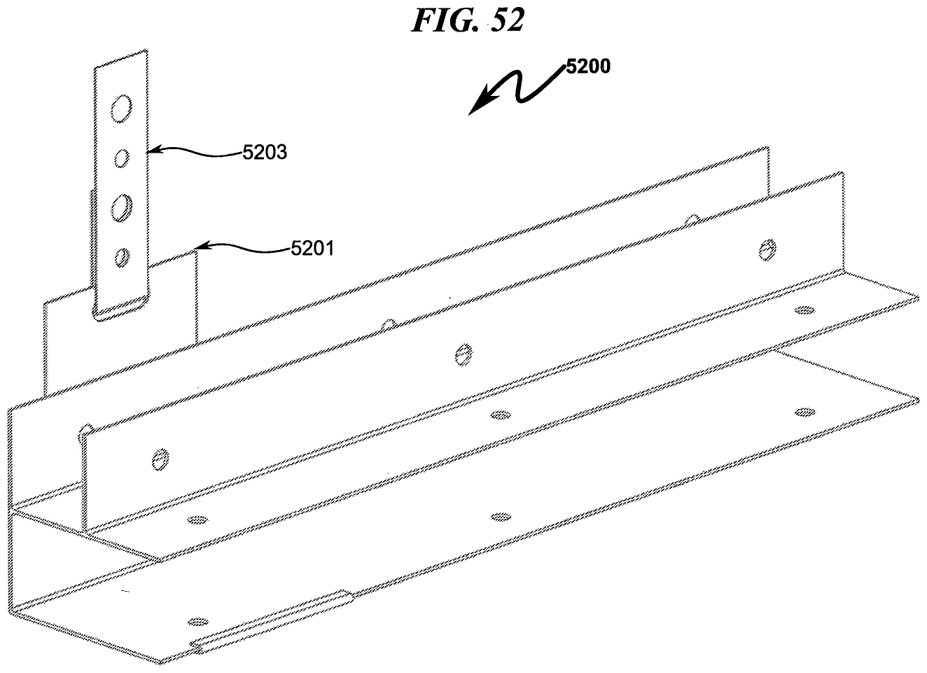

FIG. 49 (4900)-FIG. 52 (5200) depict various views of an exemplary EIS wire/strap support hangar clip bracket (4901, 5001, 5101, 5201) that mates with the lower lip of an EIS structure using a folded hem structure (4902). FIG. 50 (5000)-FIG. 52 (5200) depict the use of this EIS wire/strap support hangar clip bracket (5001, 5101, 5201) in which galvanized pipe strap (typically configured as 22-gauge×0.75-inch galvanized metal perforated plumbers tape) (5003, 5103, 5203) is used to support the EIS/bracket structure. One skilled in the art will recognize that this hangar arrangement may also be used with a variety of wire and other support fastening means.

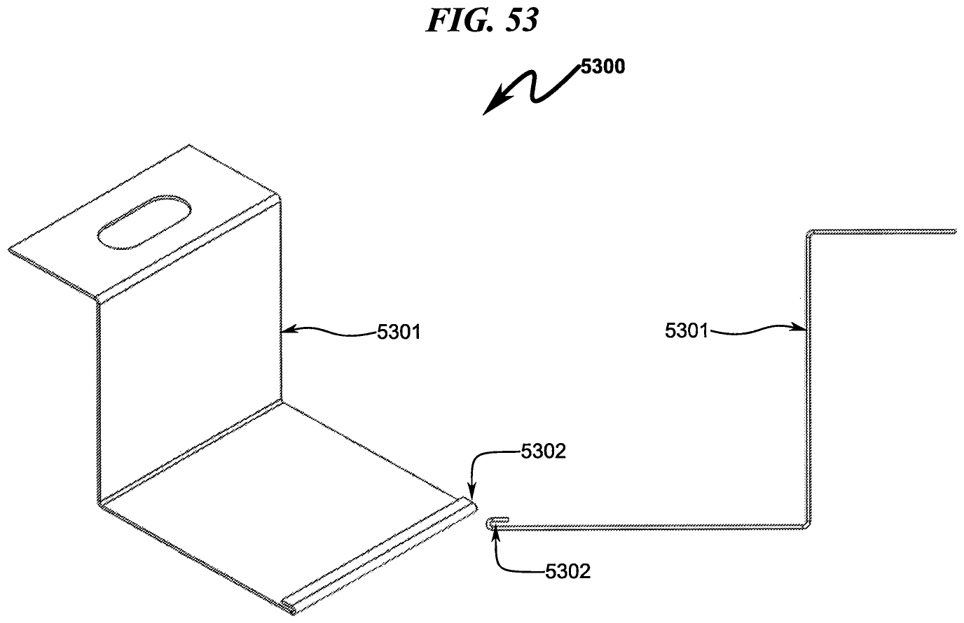

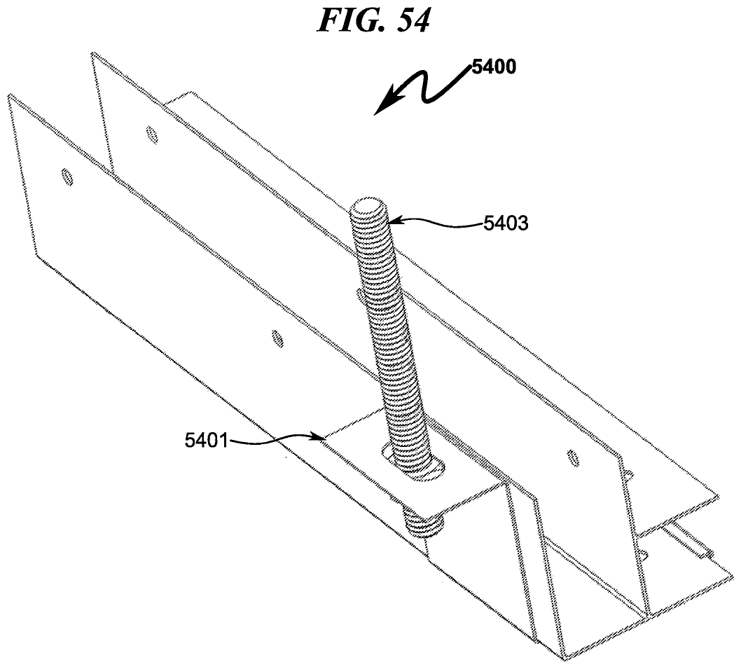

FIG. 53 (5300)-FIG. 56 (5600) depict various views of an exemplary EIS rod support hangar clip bracket (5301, 5401, 5501, 5601) that mates with the lower lip of an EIS structure using a folded hem structure (5302). FIG. 54 (5400)-FIG. 56 (5600) depict the use of this EIS rod support hangar clip bracket (5401, 5501, 5601) in which threaded rod (“all-thread”) (5403, 5503, 5603) in conjunction with a suitable nut fastener (5504) is used to support the EIS/bracket structure. While threaded rod is commonly used in this application context, one skilled in the art will recognize that a wide variety of other support fastening means may be used in this application context.

### Right Angle Corner (RAC) EIS Variants (5700)-(6400)

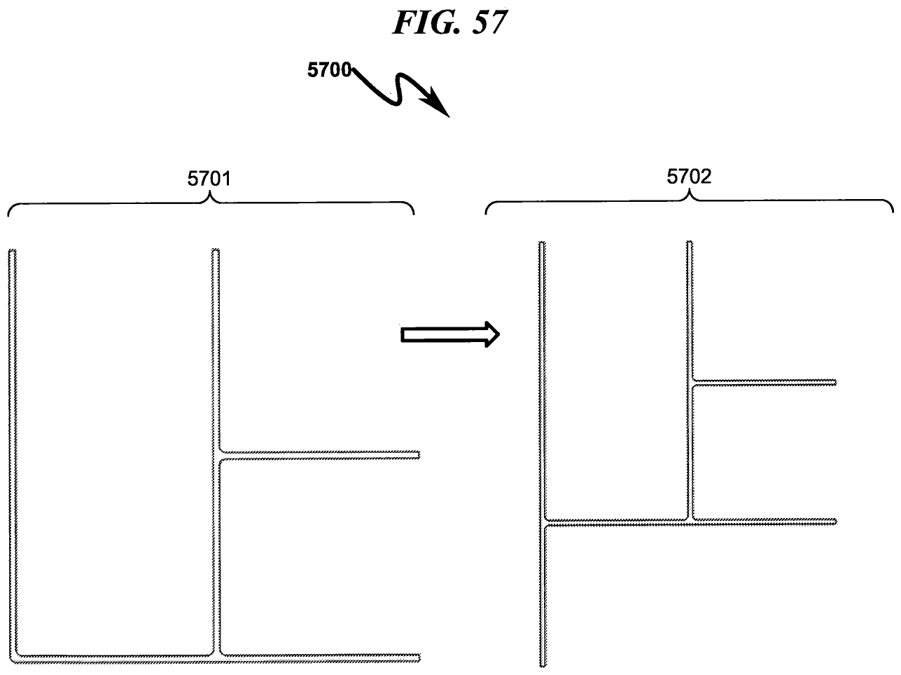

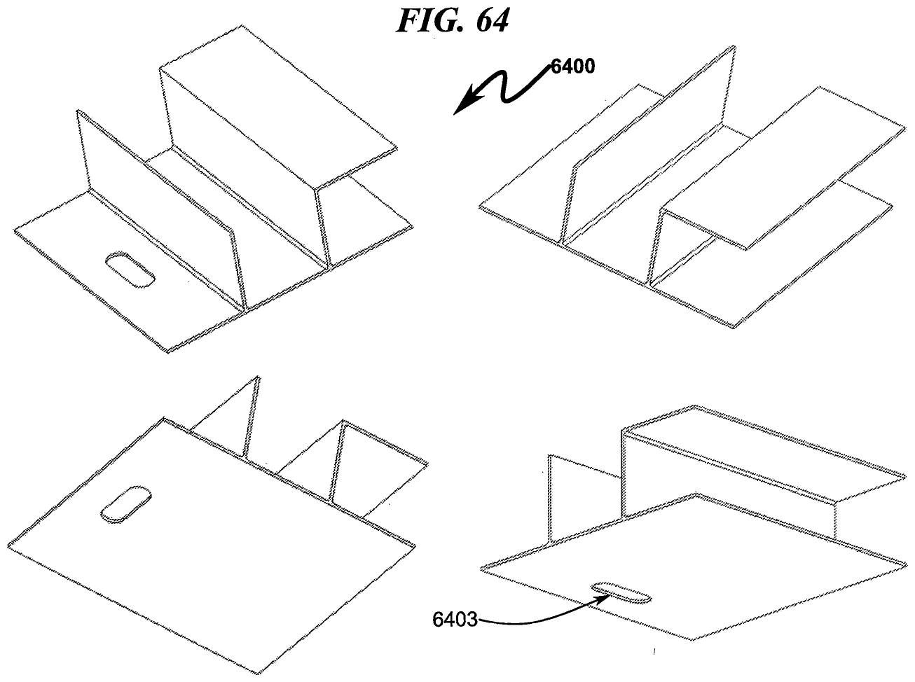

In addition to the EIS hangar clips depicted in FIG. 49 (4900)-FIG. 56 (5600), the RAC EIS may be implemented in a variety of configurations in which the extrusion permits direct attachment to the EIS structure. These variations are generally depicted the NEP profiles (0930, 0940, 0950, 0960) of FIG. 9 (0900) and are depicted in typical extrusion profile form in FIG. 57 (5700)-FIG. 64 (6400).

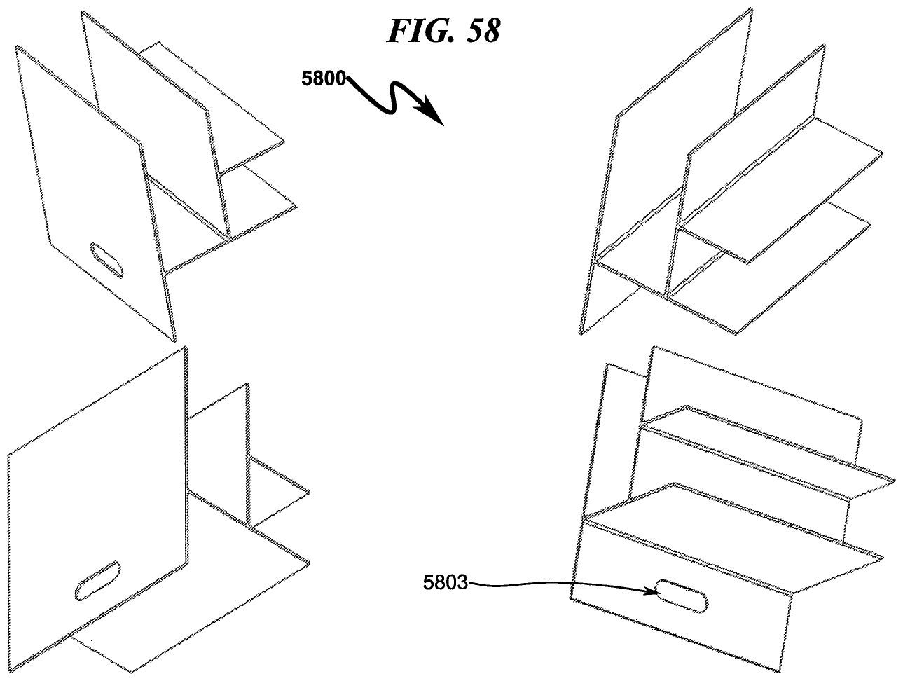

FIG. 57 (5700) compares a conventional RAC EIS structure (5701) as compared to one incorporating a horizontal support tab (5702) for attachment to a horizontal surface or support structure. FIG. 58 (5800) depicts various perspective views of the horizontal support EIS structure and a typical mounting fastener hole (5803).

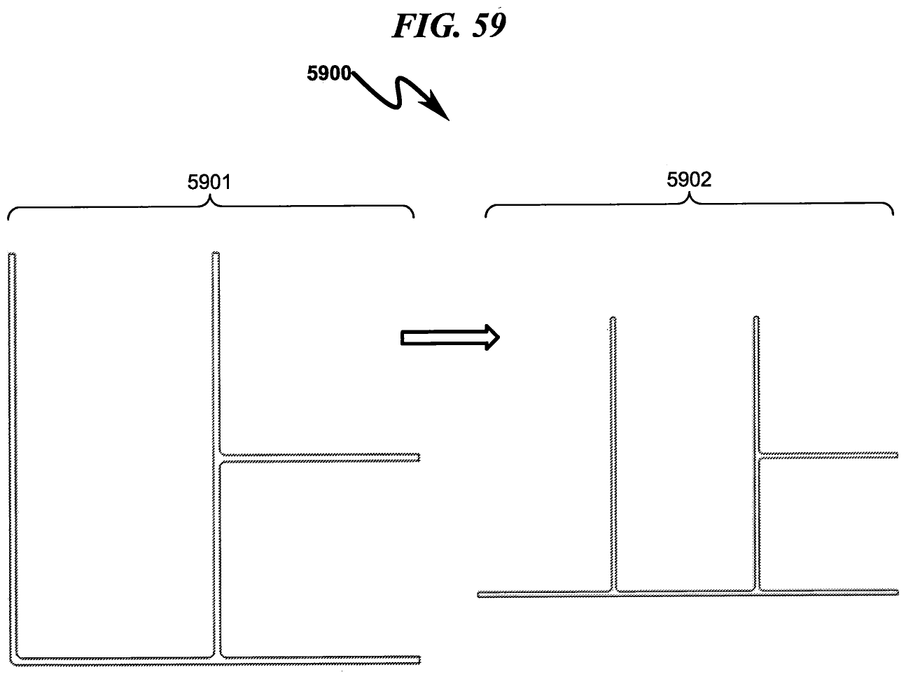

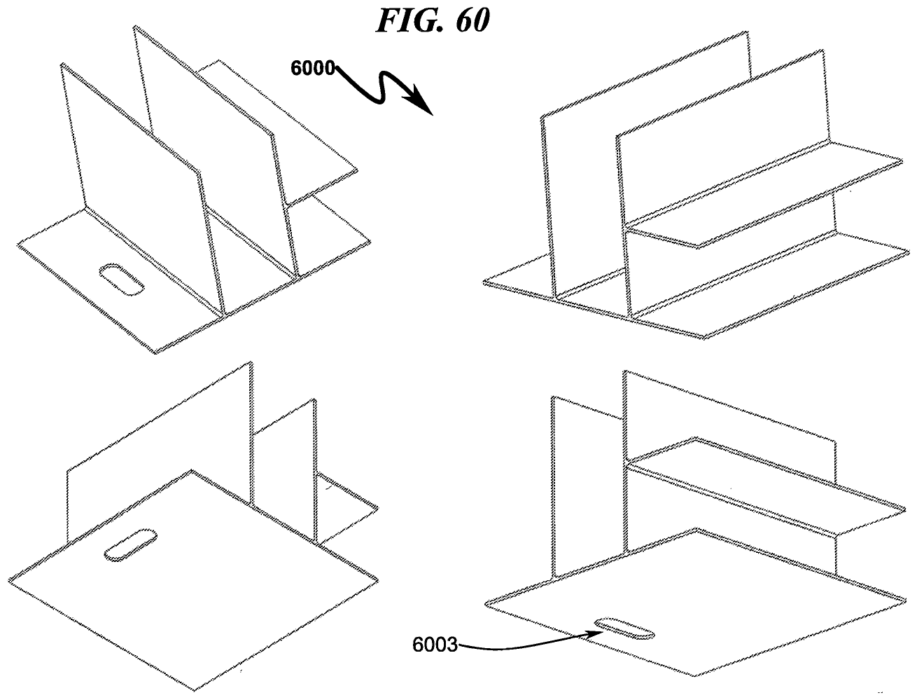

FIG. 59 (5900) compares a conventional RAC EIS structure (5901) as compared to one incorporating a vertical support tab (5902) for attachment to a vertical surface or support structure. FIG. 60 (6000) depicts various perspective views of the vertical support EIS structure and a typical mounting fastener hole (6003).

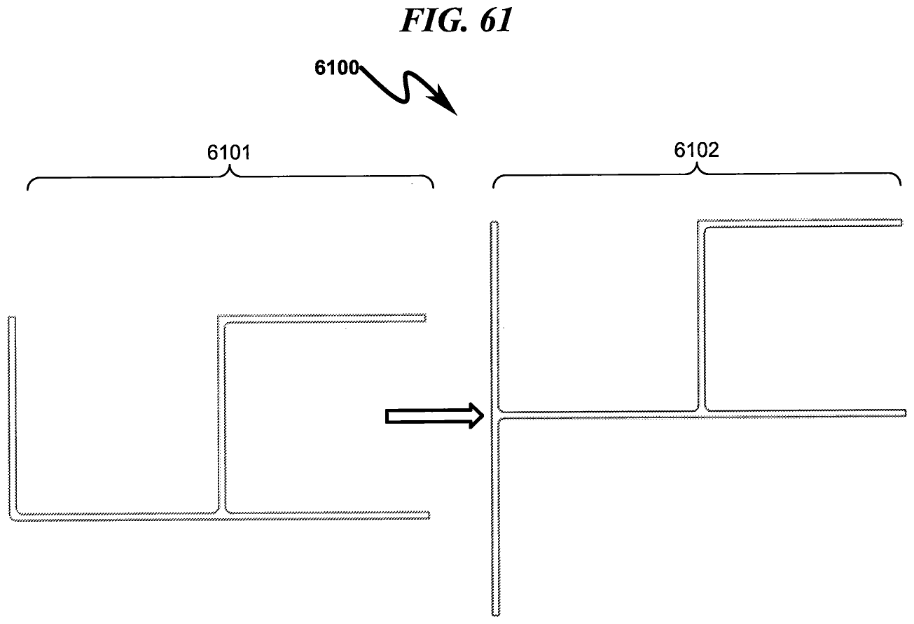

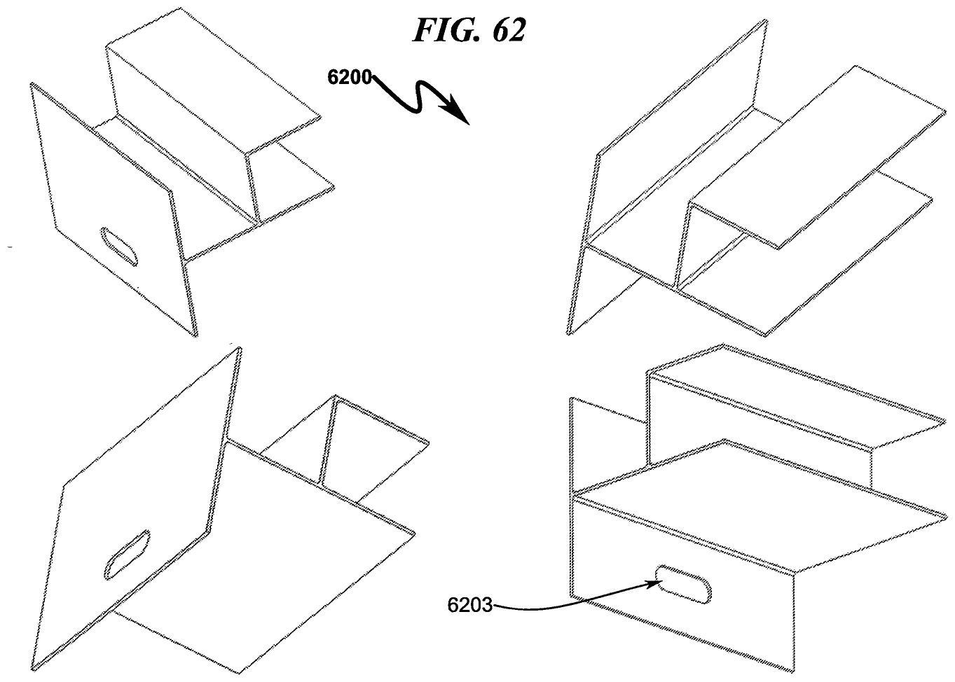

FIG. 61 (6100) compares a conventional compact RAC EIS structure (6101) as compared to one incorporating a horizontal support tab (6102) for attachment to a horizontal surface or support structure. FIG. 62 (6200) depicts various perspective views of the horizontal support EIS structure and a typical mounting fastener hole (6203).

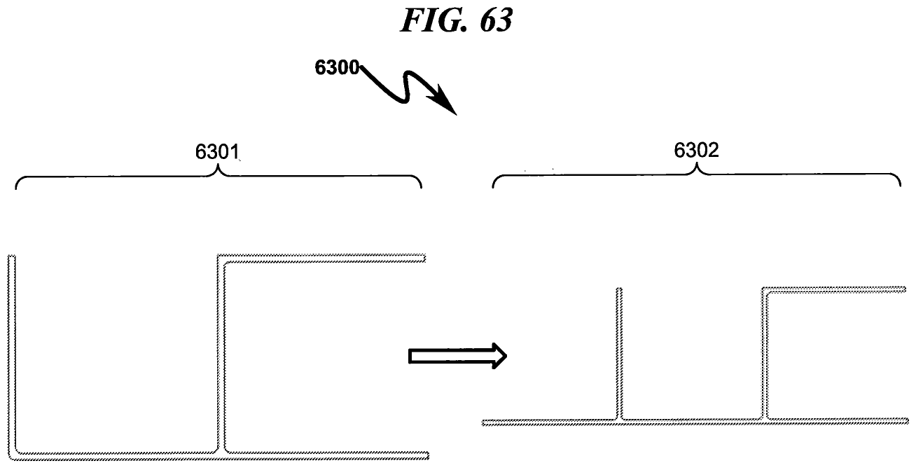

FIG. 63 (6300) compares a conventional compact RAC EIS structure (6301) as compared to one incorporating a vertical support tab (6302) for attachment to a vertical surface or support structure. FIG. 64 (6400) depicts various perspective views of the vertical support EIS structure and a typical mounting fastener hole (6403).

### Exemplary HVAC RAC+PSC Duct Structure (6500)-(7200)

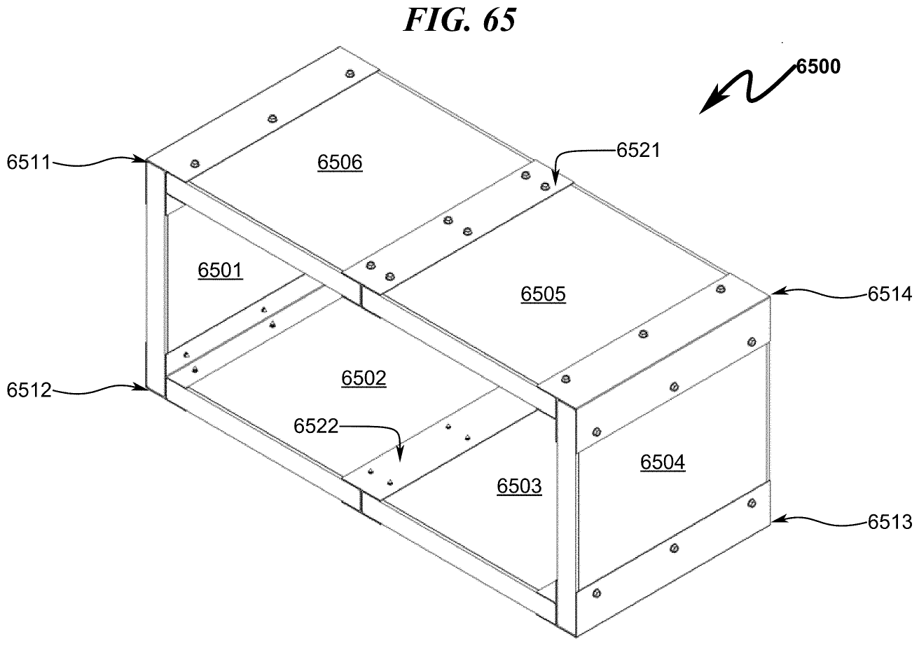

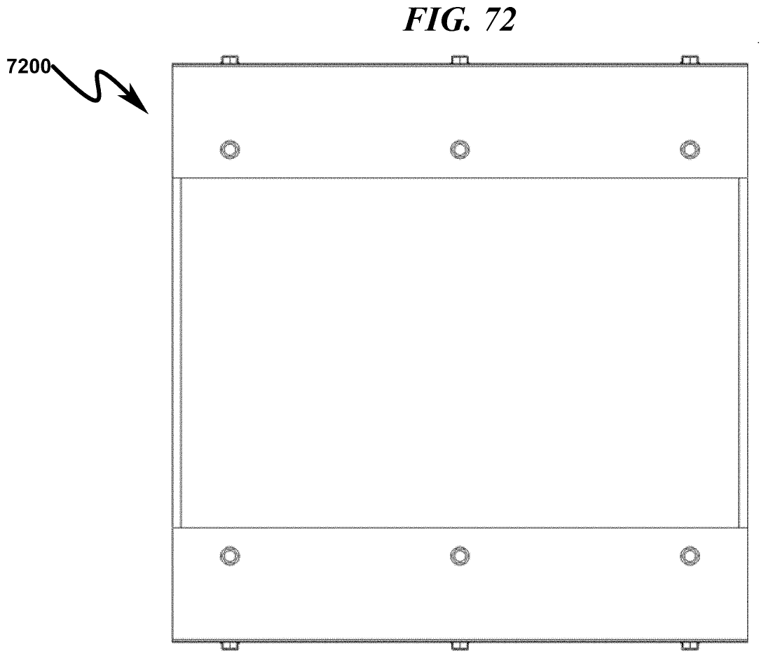

An exemplary HVAC duct structure constructed using the teachings of the present invention is generally depicted in FIG. 65 (6500)-FIG. 72 (7200). Here it can be seen that duct board (6501, 6502, 6503, 6504, 6505, 6506) is retained by the RAC EIS structures (6511, 6512, 6513, 6514) and PSC EIS structures (6521, 6522). As indicated in this diagram, the use of the PSC EIS structures (6521, 6522) may be used to arbitrarily extend the length and/or width of a DBS sheet section as needed based on the needs of the particular application context.

### Exemplary HVAC RCC+RAC+PIC Duct Structure (7300)-(8000)

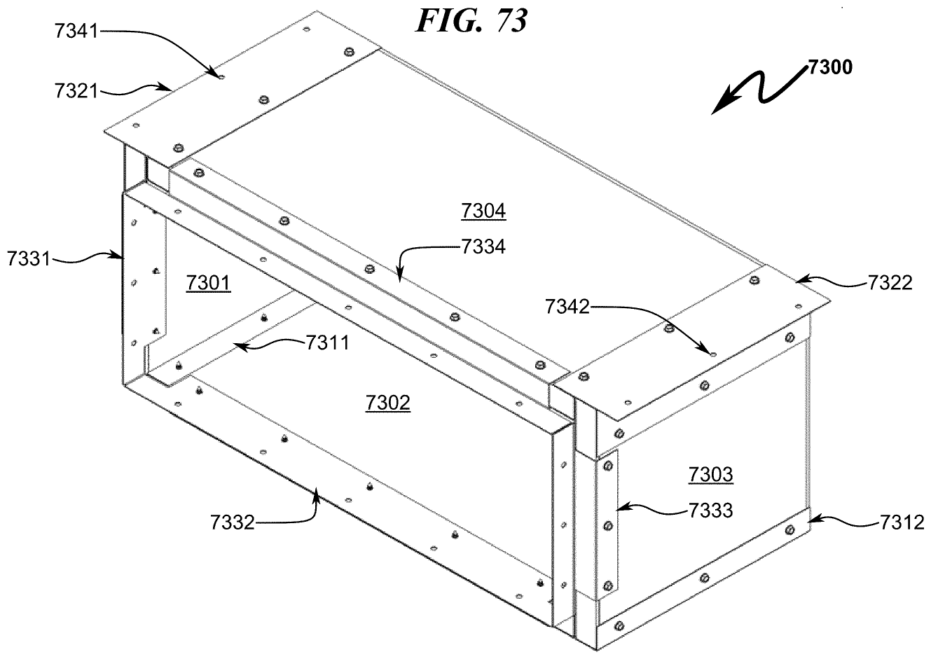

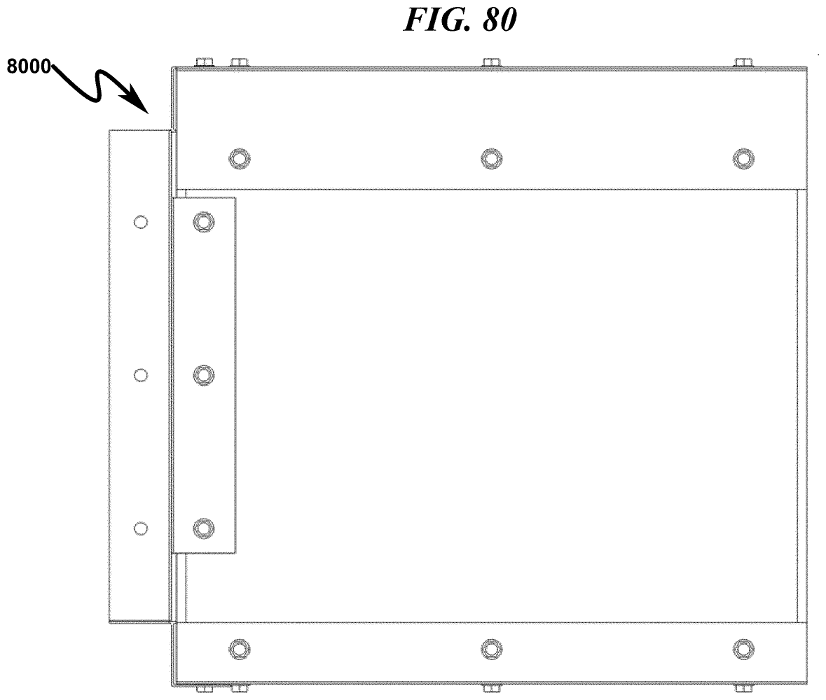

An exemplary HVAC duct structure constructed using the teachings of the present invention is generally depicted in FIG. 73 (7300)-FIG. 80 (8000). Here it can be seen that duct board (7301, 7302, 7303, 7304) is retained by the RCC (7311, 7312) EIS structures and the RAC vertical support EIS structures (7321, 7322). As indicated in this diagram, the use of the RAC PIC structures (7331, 7332, 7333, 7334) may be used to mate the HVAC duct structure to an existing HVAC unit or some other air containment structure. The RAC structures (7321, 7322) depicted have been augmented to permit support of the HVAC system via vertical supports (as seen by the support holes (7341, 7342) provided for in the RAC structures (7321, 7322)).

### Exemplary HVAC RCC+RAC+SIC Duct Structure (8100)-(8800)

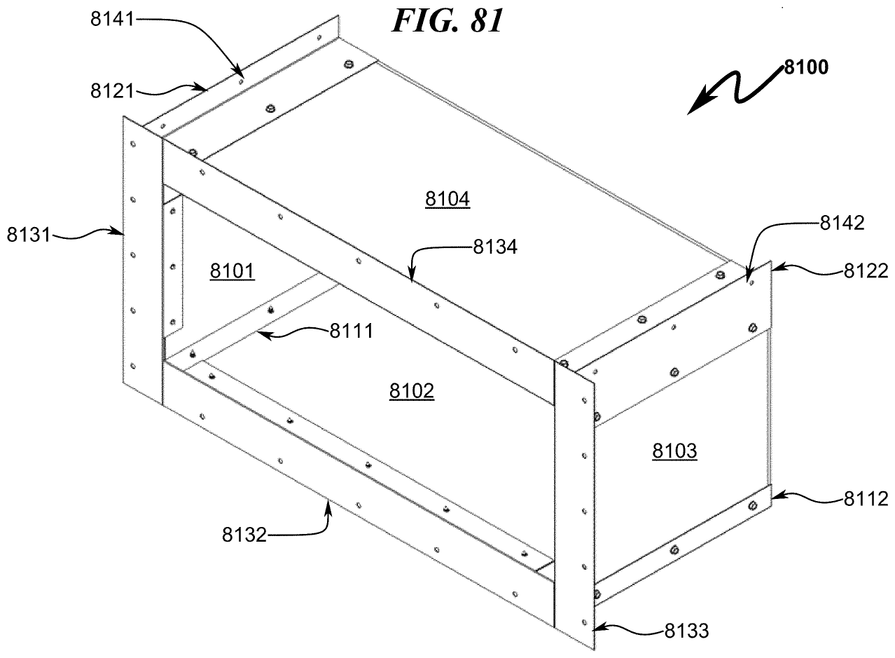

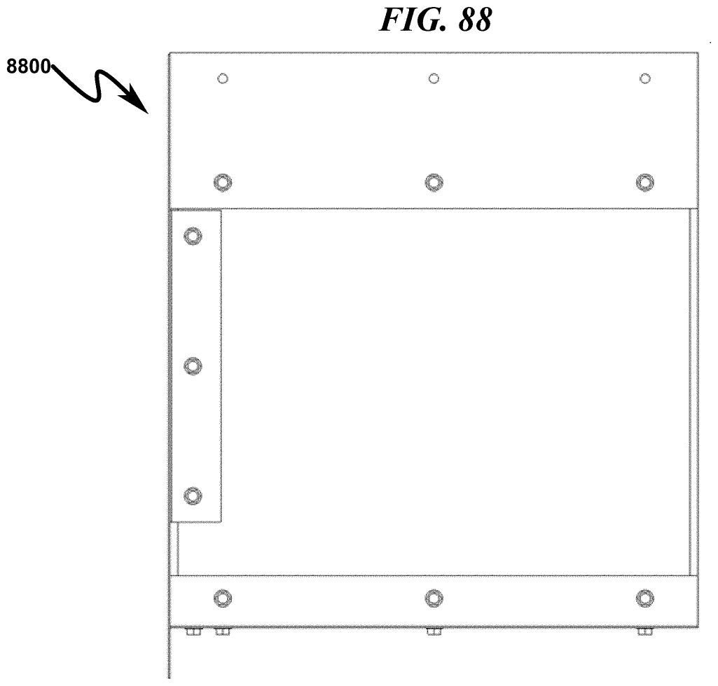

Another exemplary HVAC duct structure constructed using the teachings of the present invention is generally depicted in FIG. 81 (8100)-FIG. 88 (8800). Here it can be seen that duct board (8101, 8102, 8103, 8104) is retained by the RCC (8111, 8112) EIS structures and the RAC horizontal support EIS structures (8121, 8122). As indicated in this diagram, the use of the RAC SIC structures (8131, 8132, 8133, 8134) may be used to mate the HVAC duct structure to an existing HVAC unit or some other air containment structure. The RAC structures (8121, 8122) depicted have been augmented to permit support of the HVAC system via horizontal supports (as seen by the support holes (8141, 8142) provided for in the RAC structures (8121, 8122)).

### Exemplary DBS Capture Profiles (8900)-(9200)

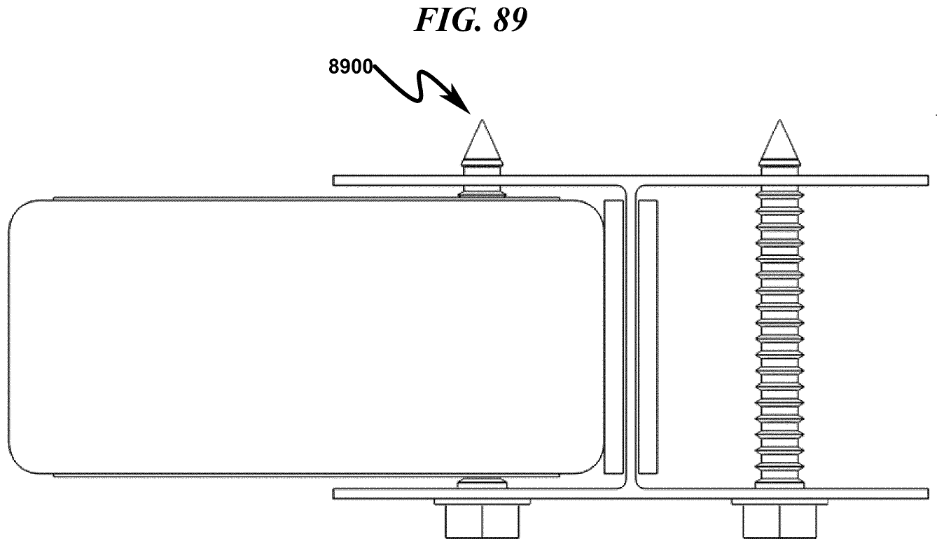

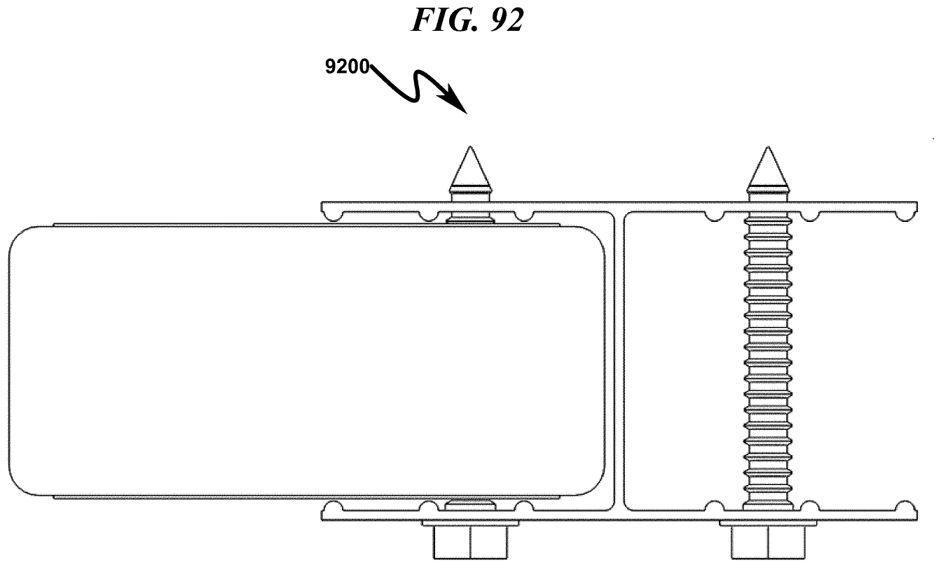

Exemplary DBS capture profiles are depicted in FIG. 89 (8900)-FIG. 92 (9200) and generally correspond to the DBS linkages generally depicted in FIG. 45 (4500) (edge sealed DBS linkage), FIG. 46 (4600) (pinned DBS linkage), FIG. 47 (4700) (ridged DBS linkage), and FIG. 48 (4800) (lobed DBS linkage) respectively.

### Sidewall Draft (9300)-(9400)

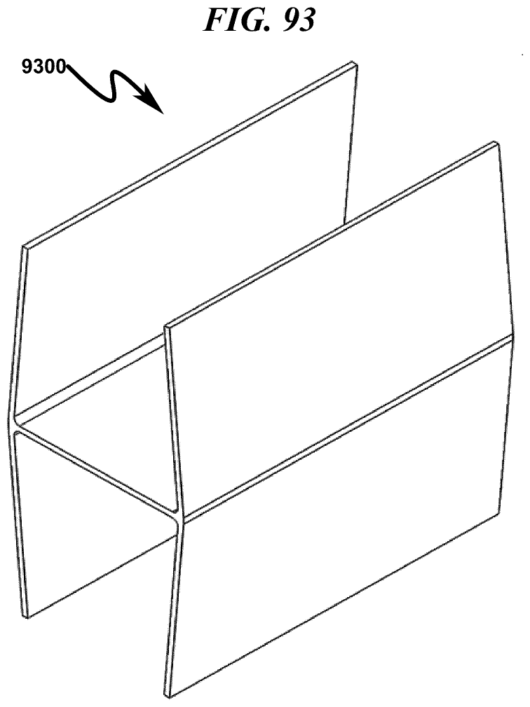

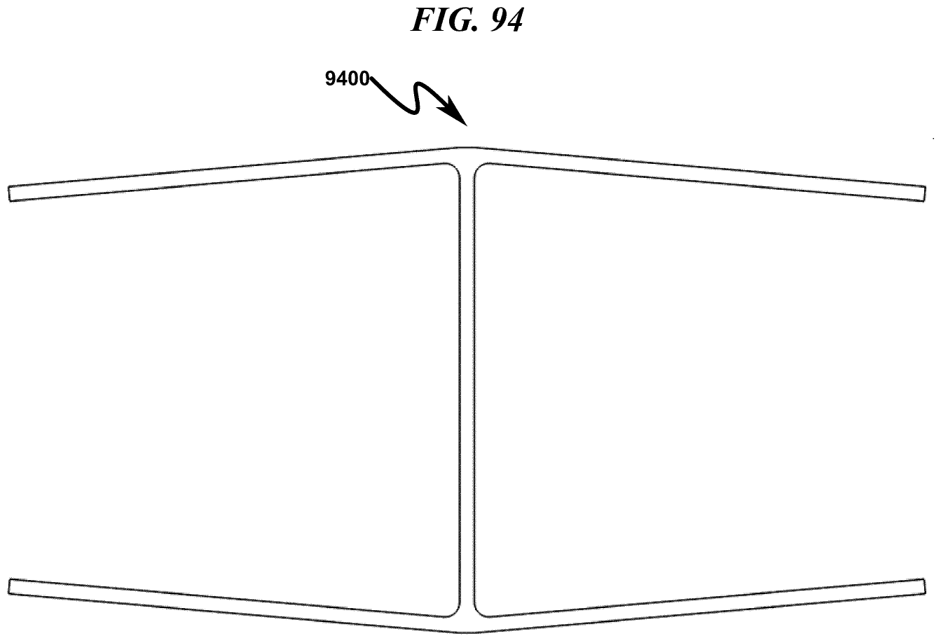

Various embodiments of the present invention may incorporate sidewall draft such that the EIS sidewalls taper when capturing the DBS. An example of this optional feature is generally depicted in FIG. 93 (9300)-FIG. 94 (9400) wherein a typical PSC EIS structure is depicted incorporating sidewall draft. This feature may be present in any of the EIS structures disclosed herein.

### Sidewall Thickness Taper (9500)-(9600)

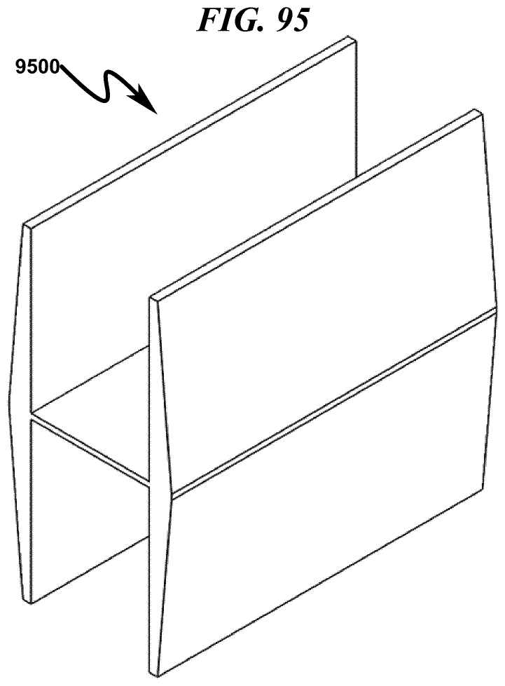

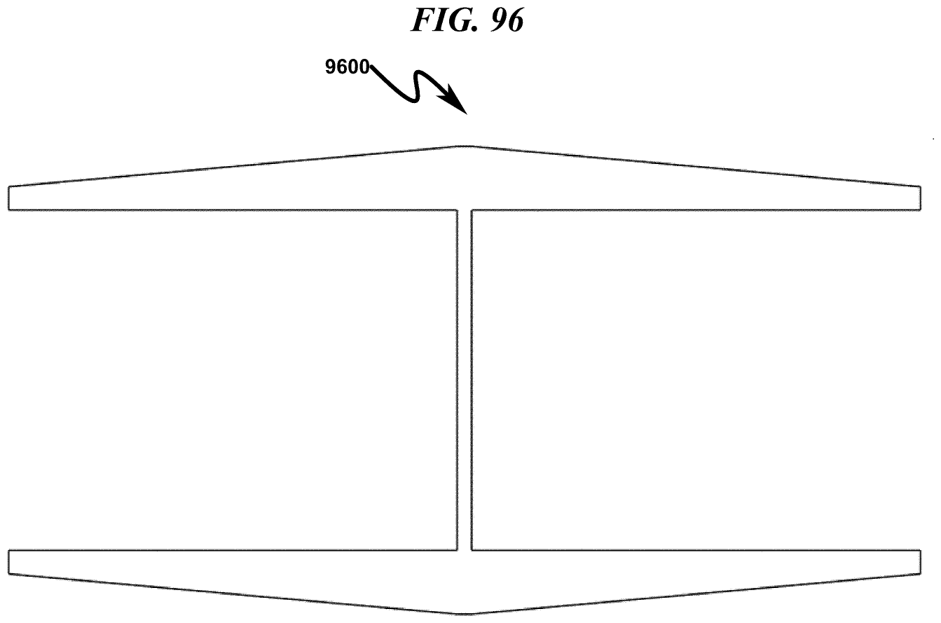

Various embodiments of the present invention may incorporate sidewall thickness taper such that the EIS sidewalls taper in thickness when capturing the DBS. An example of this optional feature is generally depicted in FIG. 95 (9500)-FIG. 96 (9600) wherein a typical PSC EIS structure is depicted incorporating sidewall draft. This feature may be present in any of the EIS structures disclosed herein.

### RAC System Summary

The present invention system in some preferred embodiments may be broadly generalized as a duct board RAC system comprising:

(a) extruded edge interconnection strip (EIS);

(b) first planar duct board sheet (FDBS); and

(c) second planar duct board sheet (SDBS);

wherein:

the EIS comprises a right angle corner connection extrusion (RAC);

the RAC comprises a normalized extrusion profile (NEP) having connected extrusion sidewall segments (ESS) comprising coordinate pairs [(0,0)-(0,2)]; [(0,0)-(2,0)]; [(1,0)-(1,2)]; and [(1,1)-(2,1)];

the RAC is configured to accept an edge of the FDBS within normalized extrusion profile (NEP) coordinate pair segments [(0,2)-(0,0)]; [(0,0)-(1,0)]; and [(1,0)-(1,2)] within the ESS; and

the RAC is configured to accept an edge of the SDBS within normalized extrusion profile (NEP) coordinate pair segments [(2,0)-(1,0)]; [(1,0)-(1,1)]; and [(1,1)-(2,1)] within the ESS.

This general system summary may be augmented by the various elements described herein to produce a wide variety of invention embodiments consistent with this overall design description.

### RCC System Summary

The present invention system in some preferred embodiments may be broadly generalized as a duct board RCC system comprising:

(a) extruded edge interconnection strip (EIS);

(b) first planar duct board sheet (FDBS); and

(c) second planar duct board sheet (SDBS);

wherein:

the EIS comprises a right angle corner connection extrusion (RAC);

the RAC comprises a normalized extrusion profile (NEP) having connected extrusion sidewall segments (ESS) comprising coordinate pairs [(0,0)-(0,1)]; [(0,0)-(2,0)]; [(1,0)-(1,1)]; and [(1,1)-(2,1)];

the RAC is configured to accept an edge of the FDBS within normalized extrusion profile (NEP) coordinate pair segments [(0,1)-(0,0)]; [(0,0)-(1,0)]; and [(1,0)-(1,1)] within the ESS; and

the RAC is configured to accept an edge of the SDBS within normalized extrusion profile (NEP) coordinate pair segments [(2,0)-(1,0)]; [(1,0)-(1,1)]; and [(1,1)-(2,1)] within the ESS.

This general system summary may be augmented by the various elements described herein to produce a wide variety of invention embodiments consistent with this overall design description.

### PSC System Summary

The present invention system in some preferred embodiments may be broadly generalized as a duct board PSC system comprising:

(a) extruded edge interconnection strip (EIS);

(b) first planar duct board sheet (FDBS); and

(c) second planar duct board sheet (SDBS);

wherein:

the EIS comprises a planar sheet connection extrusion (PSC);

the PSC comprises a normalized extrusion profile (NEP) having connected extrusion sidewall segments (ESS) comprising coordinate pairs [(0,0)-(0,2)]; [(1,0)-(1,2)]; and [(0,1)-(1,1)];

the PSC is configured to accept an edge of the FDBS within normalized extrusion profile (NEP) coordinate pair segments [(0,2)-(0,1)]; [(0,1)-(1,1)]; and [(1,1)-(1,2)] within the ESS; and

the PSC is configured to accept an edge of the SDBS within normalized extrusion profile (NEP) coordinate pair segments [(0,0)-(0,1)]; [(0,1)-(1,1)]; and [(1,1)-(1,0)] within the ESS.

This general system summary may be augmented by the various elements described herein to produce a wide variety of invention embodiments consistent with this overall design description.

### PIC System Summary

The present invention system in some preferred embodiments may be broadly generalized as a duct board PIC system comprising:

(a) extruded edge interconnection strip (EIS); and

(b) planar duct board sheet (DBS);

wherein:

the EIS comprises a planar interface connection extrusion (PIC);

the PIC comprises a normalized extrusion profile (NEP) having connected extrusion sidewall segments (ESS) comprising coordinate pairs [(0,0)-(0,2)]; [(0,1)-(1,1)]; and [(1,1)-(1,0)]; and

the PIC is configured to accept an edge of the DBS within normalized extrusion profile (NEP) coordinate pair segments [(0,0)-(0,1)]; [(0,1)-(1,1)]; and [(1,1)-(1,0)] within the ESS.

This general system summary may be augmented by the various elements described herein to produce a wide variety of invention embodiments consistent with this overall design description.

### SIC System Summary

The present invention system in some preferred embodiments may be broadly generalized as a duct board SIC system comprising:

(a) extruded edge interconnection strip (EIS); and

(b) planar duct board sheet (DBS);

wherein:

the EIS comprises a planar interface connection extrusion (PIC);

the PIC comprises a normalized extrusion profile (NEP) having connected extrusion sidewall segments (ESS) comprising coordinate pairs [(0,0)-(0,1)]; [(0,1)-(2,1)]; and [(1,0)-(1,1)]; and

the PIC is configured to accept an edge of the DBS within normalized extrusion profile (NEP) coordinate pair segments [(0,0)-(0,1)]; [(0,1)-(1,1)]; and [(1,1)-(1,0)] within the ESS.

This general system summary may be augmented by the various elements described herein to produce a wide variety of invention embodiments consistent with this overall design description.

### Method Summary

The present invention method may be broadly generalized as a duct board operating on a RAC duct board system, said RAC system comprising:

(a) extruded edge interconnection strip (EIS);

(b) first planar duct board sheet (FDBS); and

(c) second planar duct board sheet (SDBS);

wherein:

said EIS comprises a right angle corner connection extrusion (RAC);

said RAC comprises a normalized extrusion profile (NEP) having connected extrusion sidewall segments (ESS) comprising coordinate pairs [(0,0)-(0,2)]; [(0,0)-(2,0)]; [(1,0)-(1,2)]; and [(1,1)-(2,1)];

said RAC is configured to accept an edge of said FDBS within normalized extrusion profile (NEP) coordinate pair segments [(0,2)-(0,0)]; [(0,0)-(1,0)]; and [(1,0)-(1,2)] within said ESS; and said RAC is configured to accept an edge of said SDBS within normalized extrusion profile (NEP) coordinate pair segments [(2,0)-(1,0)]; [(1,0)-(1,1)]; and [(1,1)-(2,1)] within said ESS;

wherein said method comprises the steps of:

(1) trimming said EIS to a predetermined length;

(2) inserting an edge of said FDBS within said normalized extrusion profile (NEP) coordinate pair segments [(0,2)-(0,0)]; [(0,0)-(1,0)]; and [(1,0)-(1,2)] within said ESS;

(3) attaching said FDBS to said ESS with a fastener;

(4) inserting an edge of said SDBS within said normalized extrusion profile (NEP) coordinate pair segments [(2,0)-(1,0)]; [(1,0)-(1,1)]; and [(1,1)-(2,1)] within said ESS; and

(5) attaching said FDBS to said ESS with a fastener.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

A corresponding method incorporating the above mentioned steps is also anticipated for RCC variants as well as PSC, PIC, and SIC EIS embodiments.

### System/Method Variations

The present invention anticipates a wide variety of variations in the basic theme of construction. The examples presented previously do not represent the entire scope of possible usages. They are meant to cite a few of the almost limitless possibilities.

This basic system, method, and product-by-process may be augmented with a variety of ancillary embodiments, including but not limited to:
An embodiment wherein the EIS comprises an extrusion material selected from the group consisting of: polyethylene (PE); polypropylene; acetal; acrylic; nylon (polyamides); polystyrene; polyvinyl chloride (PVC); acrylonitrile butadiene styrene (ABS); polycarbonate; aluminum; aluminum alloys; copper; copper alloys; steel; steel alloys; and galvanized sheet metal.
An embodiment wherein the EIS comprises sheet metal.
An embodiment wherein the EIS comprises a plurality of spaced sidewall fastener holes.
An embodiment wherein the EIS comprises an interior fastener, the fastener selected from a group consisting of: double-sided tape having one side affixed to a base extrusion of the EIS; pin fastener edge linkage between sidewalls of the EIS and normal to a base extrusion of the EIS; ridged sidewall extrusions; and lobed sidewall extrusions.
An embodiment wherein the EIS comprises a hangar clip comprising a hem configured to capture an edge of the EIS.
An embodiment wherein the EIS comprises extrusion walls incorporating angular sidewall draft.
An embodiment wherein the EIS comprises a sidewall thickness taper.
An embodiment wherein the EIS comprises an extrusion wall thickness in the range of 0.010 inches to 0.075 inches.
An embodiment wherein the EIS is configured to accept a planar duct board sheet having a thickness selected from a group consisting of: 0.5 inches; 1.0 inches; 1.5 inches; and 2.0 inches.

One skilled in the art will recognize that other embodiments are possible based on combinations of these variations and other elements taught within the above invention description.

### CONCLUSION

A duct board system/method utilizing extruded edge interconnection strips (EIS) has been disclosed. The EIS are formed to allow linkage of planar duct board sheets (DBS) in a variety of connection methodologies including right angle corner connections (RAC), planar sheet connections (PSC), planar interface connections (PIC), and surface interface connections (SIC), without the need for specialized DBS cutting tools or fabrication dies. The EIS may incorporate provisions for spaced and/or on-demand fastener connection of DBS to the EIS, provisions for ridged/lobed/edged linkage of the DBS to the EIS, as well as provisions for edge sealed linkage of the DBS to the EIS.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112(f) and such claim shall be construed to cover the corresponding structure, material, or acts described in the specification and equivalents thereof.
The phrase “MEANS FOR” specifically invokes the means-plus-function claims limitation recited in 35 U.S.C. § 112(f) and such claim shall be construed to cover the corresponding structure, material, or acts described in the specification and equivalents thereof.
The phrase “STEP FOR” specifically invokes the step-plus-function claims limitation recited in 35 U.S.C. § 112(f) and such claim shall be construed to cover the corresponding structure, material, or acts described in the specification and equivalents thereof.
The step-plus-function claims limitation recited in 35 U.S.C. § 112(f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

1. A duct board system comprising:
(a) extruded edge interconnection strip (EIS);
(b) first planar duct board sheet (FDBS); and
(c) second planar duct board sheet (SDBS);
wherein:
said EIS comprises a right angle corner connection extrusion (RAC);
said RAC comprises a normalized extrusion profile (NEP) having connected extrusion sidewall segments (ESS) comprising coordinate pairs [(0,0)-(0,2)]; [(0,0)-(2,0)]; [(1,0)-(1,2)]; and [(1,1)-(2,1)];
said RAC is configured to accept an edge of said FDBS within normalized extrusion profile (NEP) coordinate pair segments [(0,2)-(0,0)]; [(0,0)-(1,0)]; and [(1,0)-(1,2)] within said ESS; and
said RAC is configured to accept an edge of said SDBS within normalized extrusion profile (NEP) coordinate pair segments [(2,0)-(1,0)]; [(1,0)-(1,1)]; and [(1,1)-(2,1)] within said ESS.

2. The duct board system of claim 1 wherein said EIS comprises an extrusion material selected from the group consisting of: polyethylene (PE); polypropylene; acetal; acrylic; nylon (polyamides); polystyrene; polyvinyl chloride (PVC); acrylonitrile butadiene styrene (ABS); polycarbonate; aluminum; aluminum alloys; copper; copper alloys; steel; steel alloys; and galvanized sheet metal.

3. The duct board system of claim 1 wherein said EIS comprises sheet metal.

4. The duct board system of claim 1 wherein said EIS comprises a plurality of spaced sidewall fastener holes.

5. The duct board system of claim 1 wherein said EIS comprises an interior fastener, said fastener selected from a group consisting of: double-sided tape having one side affixed to a base extrusion of said EIS; pin fastener edge linkage between sidewalls of said EIS and normal to a base extrusion of said EIS; ridged sidewall extrusions; and lobed sidewall extrusions.

6. The duct board system of claim 1 wherein said EIS comprises a hangar clip comprising a hem configured to capture an edge of said EIS.

7. The duct board system of claim 1 wherein said EIS comprises extrusion walls incorporating angular sidewall draft.

8. The duct board system of claim 1 wherein said EIS comprises a sidewall thickness taper.

9. The duct board system of claim 1 wherein said EIS comprises an extrusion wall thickness in the range of 0.010 inches to 0.075 inches.

10. The duct board system of claim 1 wherein said EIS is configured to accept a planar duct board sheet having a thickness selected from a group consisting of: 0.5 inches; 1.0 inches; 1.5 inches; and 2.0 inches.

11. A duct board method operating on a duct board system, said system comprising:
(a) extruded edge interconnection strip (EIS);
(b) first planar duct board sheet (FDBS); and
(c) second planar duct board sheet (SDBS);
wherein:
said EIS comprises a right angle corner connection extrusion (RAC);
said RAC comprises a normalized extrusion profile (NEP) having connected extrusion sidewall segments (ESS) comprising coordinate pairs [(0,0)-(0,2)]; [(0,0)-(2,0)]; [(1,0)-(1,2)]; and [(1,1)-(2,1)];
said RAC is configured to accept an edge of said FDBS within normalized extrusion profile (NEP) coordinate pair segments [(0,2)-(0,0)]; [(0,0)-(1,0)]; and [(1,0)-(1,2)] within said ESS; and
said RAC is configured to accept an edge of said SDBS within normalized extrusion profile (NEP) coordinate pair segments [(2,0)-(1,0)]; [(1,0)-(1,1)]; and [(1,1)-(2,1)] within said ESS;
wherein said method comprises the steps of:
(1) trimming said EIS to a predetermined length;
(2) inserting an edge of said FDBS within said normalized extrusion profile (NEP) coordinate pair segments [(0,2)-(0,0)]; [(0,0)-(1,0)]; and [(1,0)-(1,2)] within said ESS;
(3) attaching said FDBS to said ESS with a fastener;
(4) inserting an edge of said SDBS within said normalized extrusion profile (NEP) coordinate pair segments [(2,0)-(1,0)]; [(1,0)-(1,1)]; and [(1,1)-(2,1)] within said ESS; and
(5) attaching said FDBS to said ESS with a fastener.

12. The duct board method of claim 11 wherein said EIS comprises an extrusion material selected from the group consisting of: polyethylene (PE); polypropylene; acetal; acrylic; nylon (polyamides); polystyrene; polyvinyl chloride (PVC); acrylonitrile butadiene styrene (ABS); polycarbonate; aluminum; aluminum alloys; copper; copper alloys; steel; steel alloys; and galvanized sheet metal.

13. The duct board method of claim 11 wherein said EIS comprises sheet metal.

14. The duct board method of claim 11 wherein said EIS comprises a plurality of spaced sidewall fastener holes.

15. The duct board method of claim 11 wherein said EIS comprises an interior fastener, said fastener selected from a group consisting of: double-sided tape having one side affixed to a base extrusion of said EIS; pin fastener edge linkage between sidewalls of said EIS and normal to a base extrusion of said EIS; ridged sidewall extrusions; and lobed sidewall extrusions.

16. The duct board method of claim 11 wherein said EIS comprises a hangar clip comprising a hem configured to capture an edge of said EIS.

17. The duct board method of claim 11 wherein said EIS comprises extrusion walls incorporating angular sidewall draft.

18. The duct board method of claim 11 wherein said EIS comprises a sidewall thickness taper.

19. The duct board method of claim 11 wherein said EIS comprises an extrusion wall thickness in the range of 0.010 inches to 0.075 inches.

20. The duct board method of claim 11 wherein said EIS is configured to accept a planar duct board sheet having a thickness selected from a group consisting of: 0.5 inches; 1.0 inches; 1.5 inches; and 2.0 inches.

21. A duct board system comprising:
(a) extruded edge interconnection strip (EIS);
(b) first planar duct board sheet (FDBS); and
(c) second planar duct board sheet (SDBS);
wherein:
said EIS comprises a right angle corner connection extrusion (RAC);
said RAC comprises a normalized extrusion profile (NEP) having connected extrusion sidewall segments (ESS) comprising coordinate pairs [(0,0)-(0,1)]; [(0,0)-(2,0)]; [(1,0)-(1,1)]; and [(1,1)-(2,1)];
said RAC is configured to accept an edge of said FDBS within normalized extrusion profile (NEP) coordinate pair segments [(0,1)-(0,0)]; [(0,0)-(1,0)]; and [(1,0)-(1,1)] within said ESS; and
said RAC is configured to accept an edge of said SDBS within normalized extrusion profile (NEP) coordinate pair segments [(2,0)-(1,0)]; [(1,0)-(1,1)]; and [(1,1)-(2,1)] within said ESS.

22. A duct board system comprising:
(a) extruded edge interconnection strip (EIS);
(b) first planar duct board sheet (FDBS); and
(c) second planar duct board sheet (SDBS);
wherein:
said EIS comprises a planar sheet connection extrusion (PSC);
said PSC comprises a normalized extrusion profile (NEP) having connected extrusion sidewall segments (ESS) comprising coordinate pairs [(0,0)-(0,2)]; [(1,0)-(1,2)]; and [(0,1)-(1,1)];
said PSC is configured to accept an edge of said FDBS within normalized extrusion profile (NEP) coordinate pair segments [(0,2)-(0,1)]; [(0,1)-(1,1)]; and [(1,1)-(1,2)] within said ESS; and
said PSC is configured to accept an edge of said SDBS within normalized extrusion profile (NEP) coordinate pair segments [(0,0)-(0,1)]; [(0,1)-(1,1)]; and [(1,1)-(1,0)] within said ESS.

23. A duct board system comprising:
(a) extruded edge interconnection strip (EIS); and
(b) planar duct board sheet (DBS);
wherein:
said EIS comprises a planar interface connection extrusion (PIC);
said PIC comprises a normalized extrusion profile (NEP) having connected extrusion sidewall segments (ESS) comprising coordinate pairs [(0,0)-(0,2)]; [(0,1)-(1,1)]; and [(1,1)-(1,0)]; and
said PIC is configured to accept an edge of said DBS within normalized extrusion profile (NEP) coordinate pair segments [(0,0)-(0,1)]; [(0,1)-(1,1)]; and [(1,1)-(1,0)] within said ESS.

24. A duct board system comprising:
(a) extruded edge interconnection strip (EIS); and
(b) planar duct board sheet (DBS);
wherein:
said EIS comprises a planar interface connection extrusion (PIC);
said PIC comprises a normalized extrusion profile (NEP) having connected extrusion sidewall segments (ESS) comprising coordinate pairs [(0,0)-(0,1)]; [(0,1)-(2,1)]; and [(1,0)-(1,1)]; and
said PIC is configured to accept an edge of said DBS within normalized extrusion profile (NEP) coordinate pair segments [(0,0)-(0,1)]; [(0,1)-(1,1)]; and [(1,1)-(1,0)] within said ESS.
